(19) United States
(12) Patent Application Publication
(10) Pub. No.: US 2025/0356559 A1
(43) Pub. Date: Nov. 20, 2025

(54) INFORMATION PROCESSING DEVICE, INFORMATION PROCESSING METHOD, AND NON-TRANSITORY STORAGE MEDIUM STORING INFORMATION PROCESSING PROGRAM

(71) Applicant: Mitsubishi Electric Corporation, Tokyo (JP)

(72) Inventors: Takahiro KASHIMA, Tokyo (JP); So OSAWA, Tokyo (JP); Shigeaki SUZUKI, Tokyo (JP)

(73) Assignee: Mitsubishi Electric Corporation, Tokyo (JP)

(21) Appl. No.: 19/281,233

(22) Filed: Jul. 25, 2025

Related U.S. Application Data
(63) Continuation of application No. PCT/JP2023/005747, filed on Feb. 17, 2023.

(51) Int. Cl. G06T 11/60; G06V 10/75

(52) U.S. Cl. CPC G06T 11/60; G06V 10/757

(57) ABSTRACT

Even when a drawing is a general one, processing for displaying the drawing and an image having a coordinate system different from that of the drawing in a superimposed manner is performed. A provisional superimposed diagram(s) is generated by using information about the parts in the drawing and information about parts in the image, overlap indexes showing overlaps between the parts in the drawing and the parts in the image are calculated to determine the parts in the image corresponding to the parts in the drawing in the provisional superimposed diagram(s), and an aggregate overlap index(es) in the provisional superimposed diagram(s) are calculated by summing the overlap indexes to determine a corresponding relationship between the parts in the drawing and the parts in the image on the basis of the aggregate overlap index(es).

### CROSS REFERENCE TO RELATED APPLICATION

This application is a Continuation of PCT International Application No. PCT/JP2023/005747, filed on Feb. 17, 2023, which is hereby expressly incorporated by reference into the present application.

### TECHNICAL FIELD

The present invention relates to an information processing device, an information processing method, and an information processing program.

### BACKGROUND ART

Some information processing devices perform processing for displaying a drawing and an image having a coordinate system different from that of the drawing in a superimposed manner.

When a three-dimensional design data as a drawing of a product and an image obtained by photographing the product are displayed in a superimposed manner, such an information processing device generates a virtual image using the drawing of the product, and searches for a pair of feature points in which local features of the virtual image and local features of the image obtained by photographing the product are similar. Then, extrinsic parameters of the camera which has captured the image are estimated on the basis of the pair of feature points, and the processing for displaying the image obtained by capturing the product and the three-dimensional design data of the product in a superimposed manner is performed using the estimated extrinsic parameters. (Patent Document 1, for example)

### PRIOR ART DOCUMENTS

### Patent Documents

[Patent Document 1] Japanese Unexamined Patent Application Publication No. 2020-17096

### SUMMARY OF THE INVENTION

### Problems to be Solved by the Invention

In such an information processing device, when the drawing is a general drawing, there is a problem that it is not possible to perform the processing for displaying the drawing and an image having a coordinate system different from that of the drawing in a superimposed manner. In order to be able to search for the pair of feature points in which the local features of the virtual image generated using the drawing and the local features of the image are similar, the drawing needs to have data which is detailed enough to generate a virtual image which can carry local features similar to the local features of the image. However, general drawings do not have such detailed data.

The present invention is made to solve the above-described problem, and an object of the present invention is to provide an information processing device capable of performing a process for displaying a drawing and an image having a coordinate system different from that of the drawing in a superimposed manner even when the drawing is a general drawing.

### Means for Solving the Problems

An information processing device according to the present invention includes: a first acquisition unit to acquire first information which is information about a drawing of an object having a plurality of parts and includes information about the plurality of parts in the drawing; a second acquisition unit to acquire second information which is information about an image of the object having a coordinate system different from that of the drawing and includes information about a plurality of parts in the image; a first determination unit to select parts in the drawing and parts in the image and to determine a provisional corresponding relationship between the parts in the drawing and the parts in the image by using the first information and the second information; a generation unit to generate a provisional superimposed diagram by matching the coordinate system of the drawing and the coordinate system of the image and thus superimposing the drawing and the image on the basis of the provisional corresponding relationship; a second determination unit to calculate overlap indexes showing overlaps between the parts in the drawing and the parts in the image in the provisional superimposed diagram using the first information and the second information and to determine the parts in the image corresponding to the parts in the drawing in the provisional superimposed diagram on the basis of the overlap indexes; a calculation unit to sum the overlap indexes used when the second determination unit determines the parts in the image corresponding to the parts in the drawing in the provisional superimposed diagram to calculate an aggregate overlap index of the provisional superimposed diagram; and a third determination unit to determine a corresponding relationship between the parts in the drawing acquired by the first acquisition unit and the parts in the image acquired by the second acquisition unit on the basis of the aggregate overlap index.

### Effects of the Invention

According to the information processing device of the present invention, even when the drawing is a general drawing, it is possible to perform processing for displaying the drawing and an image having a coordinate system different from that of the drawing in a superimposed manner. This is because a provisional superimposed diagram(s) is generated on the basis of a provisional corresponding relationship(s) determined using first information and second information, an aggregate overlap index(es) of the provisional superimposed diagram(s) is obtained, and then, a corresponding relationship between parts on a drawing and parts in an image is determined on the basis of the aggregate overlap index(es). Since local features are not used to obtain the corresponding relationship as in the prior art, it is not necessary to provide information about features in a drawing, and thus, a general drawing created by a CAD system or the like can be used.

### BRIEF DESCRIPTION OF THE DRAWINGS

FIG. 1 is a block diagram showing a hardware configuration of a computer capable of functioning as an information processing device according to Embodiment 1 of the present invention.

FIG. 2 is a block diagram showing a functional configuration of the information processing device according to Embodiment 1 of the present invention.

FIG. 3 is a flowchart showing an information processing method using the information processing device according to Embodiment 1 of the present invention.

FIG. 4 is a diagram for describing a third processing step and a fourth processing step of the information processing method using the information processing device according to Embodiment 1 of the present invention, and shows an example of processing performed in the third processing step and the fourth processing step.

FIG. 5 is a diagram for describing a third processing step and a fourth processing step of the information processing method using the information processing device according to Embodiment 1 of the present invention, and shows another example of processing performed in the third processing step and the fourth processing step.

FIG. 6 is a diagram for describing a fifth processing step of the information processing method using the information processing device according to Embodiment 1 of the present invention, and is a diagram for describing a method of determining a part in an image corresponding to a part in a drawing in a provisional superimposed diagram.

FIG. 7 is a diagram for describing the fifth processing step of the information processing method using the information processing device according to Embodiment 1 of the present invention, and is a diagram for describing how to calculate overlap indexes.

FIG. 8 is a block diagram showing a functional configuration of an information processing device according to Embodiment 2 of the present invention.

FIG. 9 is a block diagram showing a functional configuration of an information processing device according to Embodiment 3 of the present invention.

FIG. 10 is a block diagram showing a functional configuration of an information processing device according to Embodiment 4 of the present invention.

FIG. 11 is a block diagram showing a functional configuration of an information processing device according to Embodiment 5 of the present invention.

FIG. 12 is a block diagram showing a functional configuration of an information processing device according to Embodiment 6 of the present invention.

FIG. 13 is a block diagram showing a functional configuration of an information processing device according to Embodiment 7 of the present invention.

FIG. 14 is a block diagram showing a functional configuration of an information processing device according to Embodiment 8 of the present invention.

### EMBODIMENTS OF THE INVENTION

### Embodiment 1

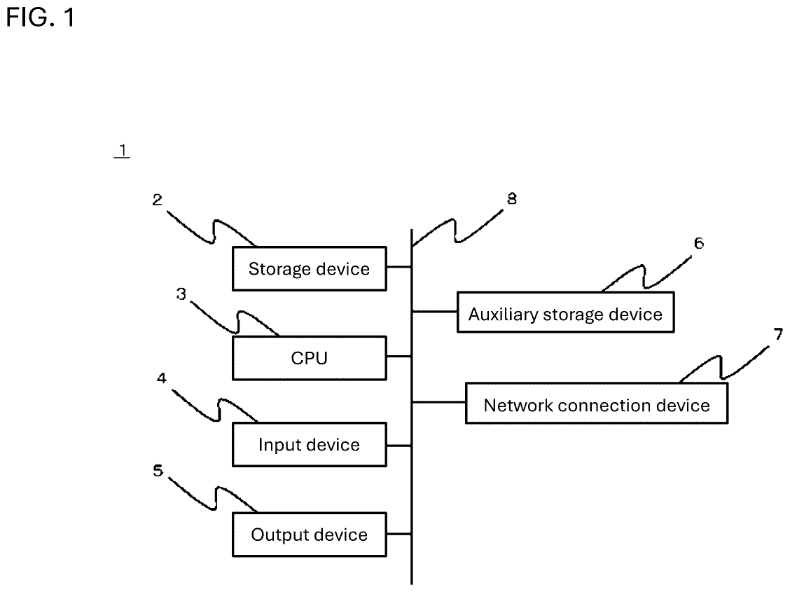

First, a configuration of an information processing device 100 according to Embodiment 1 of the present invention will be described. The information processing device 100 according to Embodiment 1 of the present invention can be realized by a computer 1. FIG. 1 is a block diagram showing a hardware configuration of the computer 1 capable of functioning as the information processing device 100 according to Embodiment 1 of the present invention. As shown in FIG. 1, the computer 1 includes a storage device 2, a central processing unit (CPU) 3, an input device 4, an output device 5, an auxiliary storage device 6, a network connection device 7, and a bus 8. The bus 8 connects the storage device 2, the CPU 3, the input device 4, the output device 5, the auxiliary storage device 6, and the network connection device 7.

The storage device 2 can be realized by a semiconductor memory such as a read only memory (ROM), a random access memory (RAM), a hard disk drive (HDD), and a flash memory. The storage device 2 stores various programs and data including an information processing program used by the CPU 3. The CPU 3 is a type of processor and executes various processes described later.

The input device 4 can be realized using, for example, a pointing device such as a mouse, a keyboard, and the like. The input device 4 is used when a user inputs an instruction, information, or the like to the computer 1. Here, the user includes a person who operates the computer 1 remotely in addition to a person who operates the computer 1 locally. The output device 5 can be realized by a display device such as a liquid crystal display. The output device 5 outputs a content of processing being performed and a result of processing having been obtained by the information processing device 100 according to the present embodiment as well as a message to the user and the like. The input device 4 and the output device 5 may be realized by, for example, a touch panel or the like having both functions of a keyboard and a display device. The input device 4 may be a combination of a keyboard and a pointing device.

The auxiliary storage device 6 can be realized using a storage device such as a magnetic disk device, an optical disk device, a magneto-optical disk device, and a magnetic tape device. The auxiliary storage device 6 stores various programs and data including an information processing program used by the CPU 3. The programs and data stored in the auxiliary storage device 6 can be used by the user by loading them into the storage device 2.

The network connection device 7 is a type of communication interface which is connected to a communication network (not shown) such as a local area network (LAN) or a wide area network (WAN) and performs data conversion associated with communication. For example, the computer 1 can receive the various programs and data from an external device connected to the communication network via the network connection device 7 and use the programs and data by loading them into the storage device 2.

The hardware configuration, shown in FIG. 1, of the computer 1 which realizes the information processing device 100 according to the present embodiment may be appropriately changed by omitting or adding a part of the components in accordance with the usage conditions, etc. of the computer 1. For example, when the computer 1 does not have to communicate with an external device, the network connection device 7 may be omitted. In addition, when the computer 1 is a portable terminal device having a communication function, the input device 4 may include a microphone, which is a type of communication device, and the output device 5 may include a speaker, which is a type of a communication device. The input device 4 may include an imaging device such as a camera.

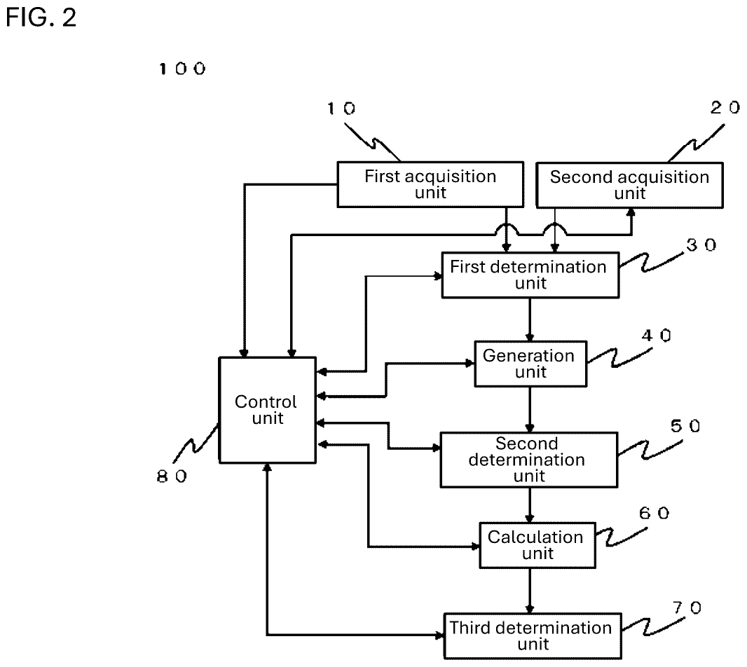

FIG. 2 is a block diagram showing a functional configuration of the information processing device 100 according to Embodiment 1 of the present invention. Each of the functions of the information processing device 100 according to Embodiment 1 of the present invention is realized by the CPU 3 of the computer 1 shown in FIG. 1. The information processing device 100 according to Embodiment 1 of the present invention performs processing for displaying a drawing and an image having a coordinate system different from that of the drawing in a superimposed manner.

The drawing in the present embodiment is a two-dimensional design data of an object having a plurality of parts, and is drawn using a computer aided design (CAD) system. The coordinate system in the drawing of the present embodiment can represent one scale division as a length based on the SI unit system in an XY orthogonal coordinate system, in which the horizontal axis is the X axis and the vertical axis is the Y axis, for example, by using millimeter for the unit per scale division. The unit may be any unit other than millimeter as long as the unit can represent the physical length of a real object, and may be, for example, meter, inch, or the like. The image in the present embodiment is obtained by capturing an image of an object having a plurality of parts using an imaging device such as a camera. The coordinate system of the image in the present embodiment uses px as the unit per scale division, and thus, cannot represent one scale division as a physical length in the XY orthogonal coordinate system, in which the horizontal axis is the X axis and the vertical axis is the Y axis.

Since one scale division in the coordinate system of the image cannot be represented as a length unlike one scale division in the coordinate system of the drawing, which can be represented as a length, the unit used for the coordinate system of the image cannot be directly converted to the unit used for the coordinate system of the drawing. Of course, the unit used for the coordinate system of the drawing cannot be directly converted to the unit used for the coordinate system of the image. When it is described in the present embodiment that the coordinate system of the drawing and the coordinate system of the image are different, it means that, due to the difference in the units per scale division, the unit used for the coordinate system of the drawing cannot be directly converted to the unit used for the coordinate system of the image or the unit used for the coordinate system of the image cannot be directly converted to the unit used for the coordinate system of the drawing.

It is described above that the drawing is a two-dimensional design data and is drawn using a CAD system, but the drawing in the present embodiment is not limited to this. Also, it is described above that the image is captured using an imaging device such as a camera, but the image in the present embodiment is not limited this. The present embodiment can cope with the cases where the drawing and the image have different coordinate systems. That is, the present embodiment works when, due to the difference in the units per scale division, the unit used for the coordinate system of the drawing cannot be directly converted to the unit used for the coordinate system of the image or the unit used for the coordinate system of the image cannot be directly converted to the unit used for the coordinate system of the drawing.

In the present embodiment, the drawing and the image are those of an object having a plurality of parts. The parts are, for example, a meter, an indicator lamp, a switch, a nameplate and the like. The object having a plurality of parts is, for example, a measurement device having a plurality of meters, a distribution board having a plurality of indicator lamps and switches, and the like. However, the parts and the object according to the present embodiment are not limited to these. In the present embodiment, a part is not just a point or a line, but is something which has an area in the drawing and in the image, that is, a part is something which can be represented by being surrounded by a closed curve in the drawing and in the image. In other words, in the present embodiment, a part in the drawing and a part in the image each have an outline. The outline is a line forming the outer shape of a thing, and the outline of a part is a line showing the outer shape of the part.

As shown in FIG. 2, the information processing device 100 according to Embodiment 1 of the present invention includes a first acquisition unit 10, a second acquisition unit 20, a first determination unit 30, a generation unit 40, a second determination unit 50, a calculation unit 60, a third determination unit 70, and a control unit 80. The first acquisition unit 10 acquires first information which is information about a drawing of an object having a plurality of parts and includes information about the parts in the drawing. The second acquisition unit 20 acquires second information which is information about an image of the object based on a coordinate system different from that of the drawing and includes information about the parts in the image. The first determination unit 30 selects the parts in the drawing and the parts in the image and determines a provisional corresponding relationship between the parts in the drawing and the parts in the image by using the first information and the second information. The generation unit 40 superimposes the drawing and the image by matching the coordinate system of the drawing and the coordinate system of the image on the basis of the provisional corresponding relationship and generates a provisional superimposed diagram.

The second determination unit 50 calculates overlap indexes showing overlaps between the parts in the drawing and the parts in the image in the provisional superimposed diagram using the first information and the second information and determines the parts in the image corresponding to the parts in the drawing in the provisional superimposed diagram on the basis of the overlap indexes. The calculation unit 60 sums the overlap indexes used when the second determination unit 50 determines the parts in the image corresponding to the parts in the drawing in the provisional superimposed diagram to calculate an aggregate overlap index of the provisional superimposed diagram. The third determination unit 70 determines a corresponding relationship between the parts in the drawing acquired by the first acquisition unit 10 and the parts in the image acquired by the second acquisition unit 20 on the basis of the aggregate overlap index(es). The control unit 80 controls operations of the first acquisition unit 10, the second acquisition unit 20, the first determination unit 30, the generation unit 40, the second determination unit 50, a calculation unit 60, and the third determination unit 70.

The first information, which is the information about the drawing, includes information about the parts in the drawing and information about the coordinate system of the drawing. The first information may include information such as information about the use and operation of the object, the outline of the object, and the like. The information about the parts in the drawing includes information about numbers of parts, types of parts, center coordinates of parts, and outlines of parts. The types of parts are categories of parts such as meters, indicator lamps, switches, nameplates, and the like. The information about the outlines of parts includes lengths of outlines, areas surrounded by outlines, and coordinates of corners when the outlines form corners. In the present embodiment, the information about the parts in the drawing does not need to include all of the numbers of parts, the types of parts, the center coordinates of parts, the lengths of outlines of parts, the areas surrounded by outlines of parts, and the coordinates of corners when the outlines of parts form corners. But the information which should be included at least is information which allows an operation of the information processing device 100 according to the present embodiment to be performed and an information processing method using the information processing device 100 according to the present embodiment to be implemented, which both will be described later. The outlines of parts may have a break as long as the operation of the information processing device 100 according to the present embodiment can be performed and the information processing method using the information processing device 100 according to the present embodiment can be implemented, which both will be described later, by compensating the break by using a known method.

The second information, which is information about the image, includes information about the parts in the image and information about the coordinate system of the image. The second information may include information such as information about the use and operation of the object, the outline of the object, and the like. The information about the parts in the drawing includes information about numbers of parts, types of parts, center coordinates of parts, and outlines of parts. In the present embodiment, similarly to the information about the parts in the drawing, the information about the parts in the image does not need to include all of the numbers of parts, the types of parts, the center coordinates of parts, the lengths of outlines of parts, the areas surrounded by outlines of parts, and the coordinates of corners when the outlines of parts form corners. But the information which should be included at least is information which allows the operation of the information processing device 100 according to the present embodiment to be performed and the information processing method using the information processing device 100 according to the present embodiment to be implemented, which both will be described later.

Since each of the functions of the information processing device 100 according to the present embodiment is realized by the CPU 3 of the computer 1 shown in FIG. 1, the first acquisition unit 10, the second acquisition unit 20, the first determination unit 30, the generation unit 40, the second determination unit 50, the calculation unit 60, the third determination unit 70, and the control unit 80, shown in FIG. 2, are functions of the CPU 3. The first information and the second information acquired by the first acquisition unit 10 and the second acquisition unit 20 are loaded in the storage device 2. Therefore, the operations of the first acquisition unit 10 and the second acquisition unit 20 of the information processing device 100 according to the present embodiment are realized by the CPU 3 obtaining the first information and the second information from the storage device 2.

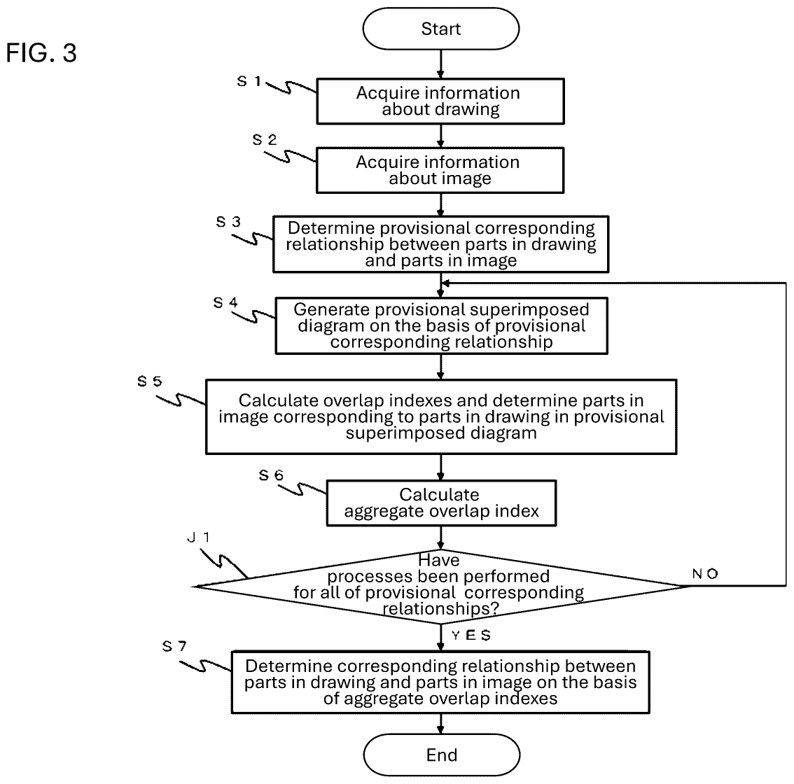

Next, the operation of the information processing device 100 according to Embodiment 1 of the present invention will be described, and the configuration of the information processing device 100 according to Embodiment 1 of the present invention will be described in more detail. FIG. 3 is a flowchart showing the information processing method using the information processing device 100 according to Embodiment 1 of the present invention.

As shown in FIG. 3, the information processing method using the information processing device 100 according to Embodiment 1 of the present invention includes a first processing step S1, a second processing step S2, a third processing step S3, a fourth processing step S4, a fifth processing step S5, a sixth processing step S6, a judgement step J1, and a seventh processing step S7.

The first processing step S1 of the information processing method using the information processing device 100 according to the present embodiment is a step of acquiring the first information which is information about the drawing of an object having a plurality of parts and includes information about the parts in the drawing. The CPU 3 having the function of the first acquisition unit 10 of the information processing device 100 according to the present embodiment acquires, in the first processing step S1, the first information which is information about the drawing of an object having a plurality of parts and includes information about the parts in the drawing from the storage device 2.

The second processing step S2 of the information processing method using the information processing device 100 according to the present embodiment is a step of acquiring the second information which is information about the image of the object having a coordinate system different from that of the drawing and includes information about the parts in the image. The CPU 3 having the function of the second acquisition unit 20 of the information processing device 100 according to the present embodiment acquires, in the second processing step S2, the second information which is information about the image of the object having a coordinate system different from that of the drawing and includes information about the parts in the image from the storage device 2.

In the present embodiment, the information about the parts in the image included in the second information is made up of a result of detecting the parts included in the image from the image obtained by imaging the object using an object detection method. Machine learning or deep learning is used for the object detection method. “You Only Look Once (YOLO) is an example of the object detection method. In addition, for example, there is a detection method using a support vector machine (SVM) with a feature obtained by a histogram of oriented gradients (HOG). From the result of detecting the parts included in the image using the object detection method, the information about the numbers of parts, the types of parts, the center coordinates of parts, and the outlines of parts is obtained, and is loaded into the storage device 2 as the information about the parts in the image.

Here, it is assumed that the process of detecting the parts included in the image using the object detection method is performed by a system other than the computer 1 capable of functioning as the information processing device 100 according to the present embodiment, and the information obtained from the result is loaded into the storage device 2. However, the present embodiment is not limited to this. For example, it is also possible that the process of detecting the parts included in the image using the object detection method is performed by the CPU 3 of the computer 1 capable of functioning as the information processing device 100 according to the present embodiment, and the information obtained from the result is loaded into the storage device 2. In the present embodiment, it suffices if the second acquisition unit 20 can acquire the information obtained from the result of detecting the parts included in the image using the object detection method.

The first acquisition unit 10 and the second acquisition unit 20 of the information processing device 100 according to the present embodiment output the acquired first information and second information to the first determination unit 30.

The third processing step S3 of the information processing method using the information processing device 100 according to the present embodiment is a process of selecting the parts in the drawing and the parts in the image and determining the provisional corresponding relationship between the parts in the drawing and the parts in the image using the first information and the second information. The CPU 3 having the function of the first determination unit 30 of the information processing device 100 according to the present embodiment selects the parts in the drawing and the parts in the image and determines the provisional corresponding relationship between the parts in the drawing and the parts in the image by using the first information and the second information in the third processing step S3.

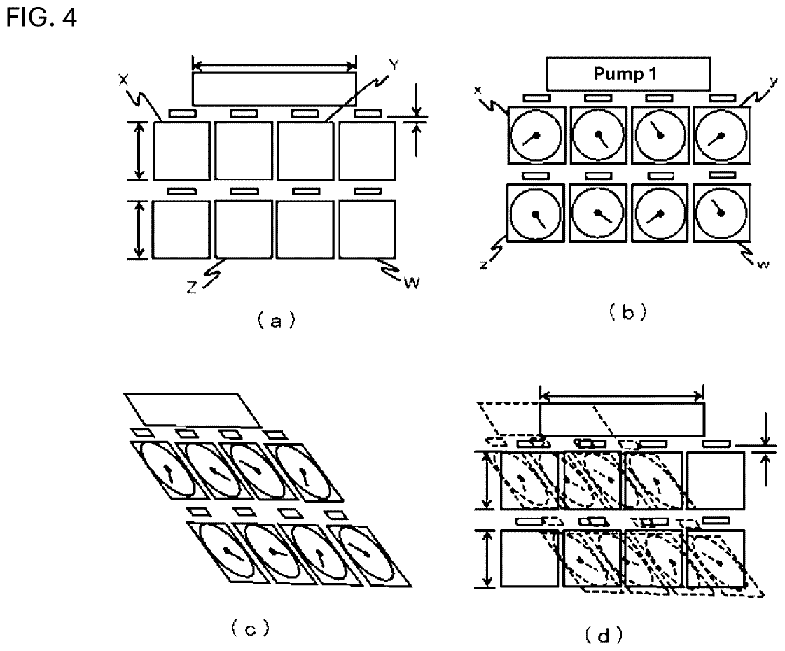

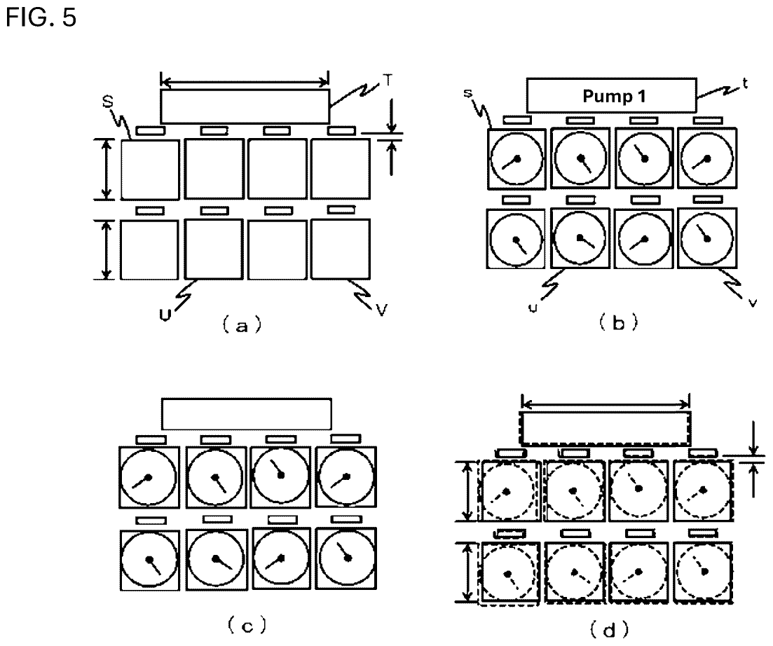

An operation of the first determination unit 30 and the third processing step S3 will be described in more detail with reference to FIGS. 4 and 5. FIGS. 4 and 5 are diagrams for describing the third processing step S3 and the fourth processing step S4 of the information processing method using the information processing device 100 according to Embodiment 1 of the present invention, and each shows a different example of the processing in the third processing step S3 and the fourth processing step S4.

FIG. 4(a) and FIG. 5(a) show diagrams representing the drawings of objects having a plurality of parts, which are depicted on the basis of the first information acquired by the first acquisition unit 10 in the first processing step S1. The letters X, Y, Z and W in FIG. 4(a) are symbols used in the following description. Similarly, the letters S, T, U and V in FIG. 5(a) are symbols used in the following description. FIG. 4(b) and FIG. 5(b) show diagrams representing the images of the objects having a plurality of parts, which are depicted on the basis of the second information acquired by the second acquisition unit 20 in the second processing step S2. The letters x, y, z and w in FIG. 4(b) are symbols used in the following description. Similarly, the letters s, t, u and v in FIG. 5(b) are symbols used in the following description. Although the outlines of the objects are not shown here in FIGS. 4 and 5 for the sake of easy understanding, it may be shown in the present embodiment.

FIG. 4(a) and FIG. 4(b) have different coordinate systems. Similarly, FIG. 5(a) and FIG. 5(b) have different coordinate systems. FIG. 4(c) is a diagram showing an image obtained by converting the coordinate system of the image shown in FIG. 4(b) into the coordinate system of the drawing shown in FIG. 4(a) to match it with the coordinate system of the drawing shown in FIG. 4(a). Matching the coordinate system of the drawing and the coordinate system of the image means making the coordinate systems identical between the drawing and the image, that is, making the unit per scale division in the coordinate system of the drawing and the unit per scale division in the coordinate system of the image the same. FIG. 4(d) is a diagram showing a provisional superimposed diagram obtained by superimposing the drawing shown in FIG. 4(a) and the image obtained by converting the coordinate system shown in FIG. 4(c). In FIG. 4(d), the solid line represents the drawing, and the broken line represents the image obtained by converting the coordinate system.

Similarly, FIG. 5(c) is a diagram showing the image obtained by converting the coordinate system of the image shown in FIG. 5(b) into the coordinate system of the drawing shown in FIG. 5(a) to match it with the coordinate system of the drawing shown in FIG. 5(a). FIG. 5(d) is a diagram showing a provisional superimposed diagram obtained by superimposing the drawing shown in FIG. 5(a) and the image obtained by converting the coordinate system shown in FIG. 5(c). In FIG. 5(d), the solid line represents the drawing, and the broken line represents the image obtained by converting the coordinate system.

As shown in FIGS. 4(a) and 4(b) as well as FIGS. 5(a) and 5(b), 17 parts are shown in each of the drawings and the images. That is, the objects shown in FIGS. 4(a) and 4(b) as well as FIGS. 5(a) and 5(b) each have 17 parts. The 17 parts are classified into 8 meters, 1 large nameplate, and 8 small nameplates. The drawings and images shown in FIGS. 4 and 5 are examples prepared to describe the third processing step S3, and drawings and images to which the processing performed by the information processing device 100 according to the present embodiment is applied are not limited to the drawings and images shown in FIGS. 4 and 5.

First, with reference to FIG. 4, a method will be described by which the first determination unit 30 of the information processing device 100 according to the present embodiment determines a provisional corresponding relationship between the parts in the drawing and the parts in the image in the third processing step S3. The first determination unit 30 selects 4 parts from the 17 parts in the drawing and 4 parts from the 17 parts in the image. For example, as shown in FIG. 4(a), the first determination unit 30 selects 4 parts with a symbol of X, Y, Z or W from the 17 parts in the drawing. Similarly, for example, as shown in FIG. 4(b), the first determination unit 30 selects 4 parts with a symbol of x, y, z or w from the 17 parts in the image.

Then, the first determination unit 30 provisionally determines the parts in the image corresponding to the selected parts in the drawing. Here, it is provisionally determined that the part X in the drawing corresponds to the part x in the image, the part Y in the drawing corresponds to the part y in the image, the part Z in the drawing corresponds to the part z in the image, and the part W in the drawing corresponds to the part w in the image. The provisionally determined relationship between the parts in the drawing and the parts in the image is the provisional corresponding relationship in FIG. 4. That is, in the provisional corresponding relationship in FIG. 4, the part X in the drawing corresponds to the part x in the image, the part Y in the drawing corresponds to the part y in the image, the part Z in the drawing corresponds to the part z in the image, and the part W in the drawing corresponds to the part w in the image.

When the parts in the drawing and the parts in the image correspond, it means that the parts in the drawing and the parts in the image in correspondence are the same parts of the object. In other words, it means that, in the provisional corresponding relationship in FIG. 4, the part X in the drawing and the part x in the image represent the same part of the object, and specifically that, in the object, they represent the same part in terms of the position, the type, the size, and the shape. The same applies to the other 3 selected parts.

Next, with reference to FIG. 5, the method will be described by which the first determination unit 30 of the information processing device 100 according to the present embodiment determines the provisional corresponding relationship between the parts in the drawing and the parts in the image in the third processing step S3. Firstly, the first determination unit 30 selects 4 parts from the 17 parts in the drawing and 4 parts from the 17 parts in the image. For example, as shown in FIG. 5(a), the first determination unit 30 selects 4 parts with a symbol of S, T, U or V from the 17 parts in the drawing. Similarly, for example, as shown in FIG. 5(b), the first determination unit 30 selects 4 parts with a symbol of s, t, u or v from the 17 parts in the image.

Then, the first determination unit 30 provisionally determines the parts in the image corresponding to the selected parts in the drawing. Here, it is provisionally determined that the part S in the drawing corresponds to the part s in the image, the part T in the drawing corresponds to the part t in the image, the part U in the drawing corresponds to the part u in the image, and the part V in the drawing corresponds to the part v in the image. The provisionally determined relationship between the parts in the drawing and the parts in the image is the provisional corresponding relationship in FIG. 5. That is, in the provisional corresponding relationship in FIG. 5, the part S in the drawing corresponds to the part s in the image, the part T in the drawing corresponds to the part t in the image, the part U in the drawing corresponds to the part u in the image, and the part V in the drawing corresponds to the part v in the image.

The first determination unit 30 of the information processing device 100 according to the present embodiment outputs the determined provisional corresponding relationship as well as the first information and the second information to the generation unit 40.

The fourth processing step S4 of the information processing method using the information processing device 100 according to the present embodiment is a step of generating the provisional superimposed diagram by matching the coordinate system of the drawing and the coordinate system of the image and thus superimposing the drawing and the image on the basis of the provisional corresponding relationship. In the fourth processing step S4, the CPU 3 having the function of the generation unit 40 of the information processing device 100 according to the present embodiment generates the provisional superimposed diagram by matching the coordinate system of the drawing and the coordinate system of the image and thus superimposing the drawing and the image on the basis of the provisional corresponding relationship determined by the first determination unit 30.

An operation of the generation unit 40 and the fourth processing step S4 will be described in more detail with reference to FIGS. 4 and 5. First, with reference to FIG. 4, a method will be described by which the generation unit 40 of the information processing device 100 according to the present embodiment generates the provisional superimposed diagram in the fourth processing step S4. The generation unit 40 calculates a projection transformation matrix for converting the coordinate system of the image into the coordinate systems of the drawing on the basis of center coordinates of the parts X, Y, Z and W in the drawing, center coordinates of the parts x, y, z and w in the image, and the provisional corresponding relationship in FIG. 4. Then, the generation unit 40 matches the coordinate system of the image shown in FIG. 4(b) with the coordinate system of the drawing shown in FIG. 4(a) by converting the image shown in FIG. 4(b) using the calculated projection transformation matrix. FIG. 4(c) is a diagram showing the image obtained by converting the image of FIG. 4(b) using the calculated projection transformation matrix. Then, as shown in FIG. 4(d), the generation unit 40 generates the provisional superimposed diagram by superimposing the drawing shown in FIG. 4(a) and the converted image shown in FIG. 4(c).

Next, with reference to FIG. 5, a method will be described by which the generation unit 40 of the information processing device 100 according to the present embodiment generates the provisional superimposed diagram in the fourth processing step S4. The generation unit 40 calculates a projection transformation matrix for converting the coordinate system of the image into the coordinate systems of the drawing on the basis of center coordinates of the parts S, T, U and V in the drawing, center coordinates of the parts s, t, u and v in the image, and the provisional corresponding relationship in FIG. 5. Then, the generation unit 40 matches the coordinate system of the image shown in FIG. 5(b) with the coordinate system of the drawing shown in FIG. 5(a) by converting the image shown in FIG. 5(b) using the calculated projection transformation matrix. FIG. 5(c) is a diagram showing the image obtained by converting the image of FIG. 5(b) using the calculated projection transformation matrix. Then, as shown in FIG. 5(d), the generation unit 40 generates the provisional superimposed diagram by superimposing the drawing shown in FIG. 5(a) and the converted image shown in FIG. 5(c).

In the present embodiment, the provisional corresponding relationship between the parts in the drawing and the parts in the image determined by the first determination unit 30 in the third processing step S3 is determined for all combinations of the parts in the drawing and the parts in the image. In the present embodiment, the object has 17 parts. In order for the generation unit 40 to calculate the projection transformation matrix in the fourth processing step S4, the first determination unit 30 selects 4 parts from the 17 parts in the drawing and 4 parts from the 17 parts in the image in the third processing step S3. Thus, the total number of provisional corresponding relationships which the first determination unit 30 can determine in the third processing step S3 is ₁₇C₄×₁₇P₄.

Here, when the first determination unit 30 determines the provisional corresponding relationship in the third processing step S3, 4 parts are selected from the 17 parts in the drawing and 4 parts are selected from the 17 parts in the image, but the present embodiment is not limited to this. For example, the first determination unit 30 may select 3 parts from the 17 parts in the drawing and 3 parts from the 17 parts in the image in the third processing step S3. When the first determination unit 30 selects 3 parts in the drawing and 3 parts in the image, the generation unit 40 can match the coordinate system of the drawing and the coordinate system of the image not by calculating the projection transformation matrix, but by calculating an affine transformation matrix in the fourth processing step S4. When the first determination unit 30 determines the provisional corresponding relationship in the third processing step S3, the number of parts to be selected from each of the parts in the drawing and the parts in the image only needs to be sufficient to calculate the conversion matrix for matching the coordinate system of the drawing and the coordinate system of the image.

The generation unit 40 calculates the projection transformation matrix for converting the coordinate system of the image into the coordinate system of the drawing on the basis of the center coordinates of the parts X, Y, Z and W in the drawing, the center coordinates of the parts x, y, z and w in the image, and the provisional corresponding relationship in FIG. 4, but the present embodiment is not limited to this. If it is possible, for example, the projection transformation matrix may be calculated on the basis of the coordinates of corners of the parts X, Y, Z and W in the drawing, the coordinates of corners of the parts x, y, z and w in the image, and the provisional corresponding relationship in FIG. 4. The same applies to the calculation of the projection transformation matrix for converting the coordinate system of the image into the coordinate system of the drawing on the basis of the center coordinates of the parts S, T, U and V in the drawing, the center coordinates of the parts s, t, u and v in the image, and the provisional corresponding relationship in FIG. 5.

The generation unit 40 of the information processing device 100 according to the present embodiment may generate the provisional superimposed diagram not by converting the coordinate system of the image into the coordinate system of the drawing, but by converting the coordinate system of the drawing into the coordinate system of the image. To describe this with reference to FIG. 4, firstly, the projection transformation matrix for converting the coordinate system of the drawing shown in FIG. 4(a) into the coordinate system of the image shown in FIG. 4(b) is calculated on the basis of the center coordinates of the parts X, Y, Z and W in the drawing, the center coordinates of the parts x, y, z and w in the image, and the provisional corresponding relationship, and then the drawing shown in FIG. 4(a) is converted using the calculated projection transformation matrix. Then, the provisional superimposed diagram is generated by matching the coordinate system of the drawing shown in FIG. 4(a) and the coordinate system of the image shown in FIG. 4(b).

The generation unit 40 of the information processing device 100 according to the present embodiment outputs the generated provisional superimposed diagram, the provisional corresponding relationship determined by the first determination unit 30, as well as the first information and the second information to the second determination unit 50.

The fifth processing step S5 of the information processing method using the information processing device 100 according to the present embodiment is a step of calculating the overlap indexes showing overlaps between the parts in the drawing and the parts in the image using the first information and the second information in the provisional superimposed diagram and determining the parts in the image corresponding to the parts in the drawing in the provisional superimposed diagram on the basis of the overlap indexes. In the fifth processing step S5, the CPU 3 having the function of the second determination unit 50 of the information processing device 100 according to the present embodiment calculates the overlap indexes showing overlaps between the parts in the drawing and the parts in the image in the provisional superimposed diagram generated by the generation unit 40 and determines the parts in the image corresponding to the parts in the drawing in the provisional superimposed diagram on the basis of the overlap indexes.

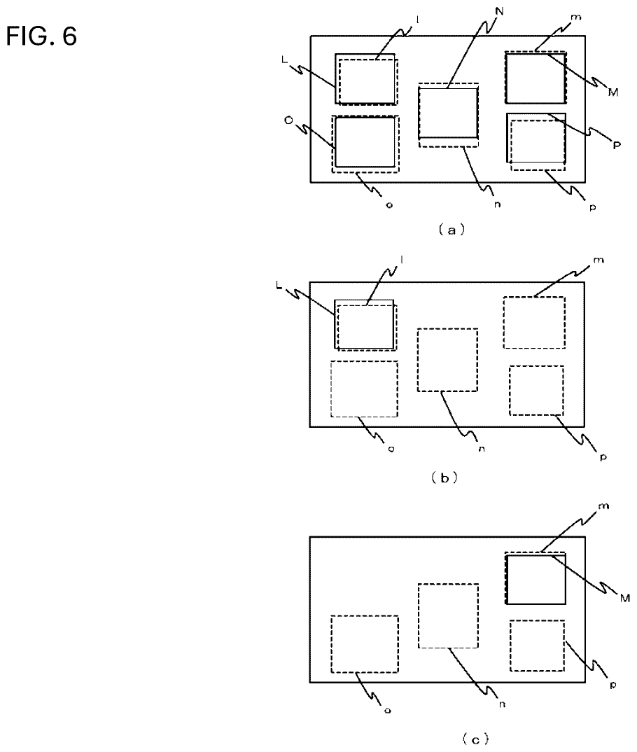

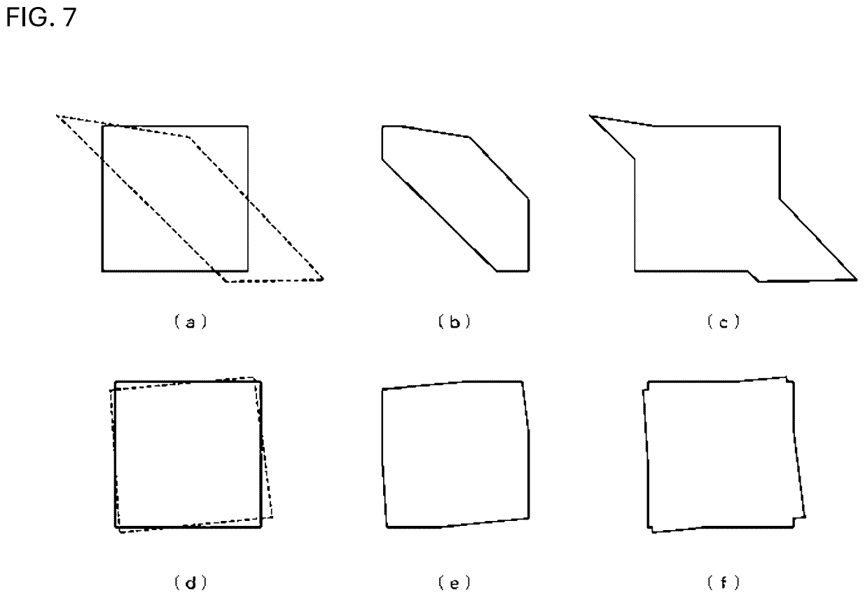

An operation of the second determination unit 50 and the fifth processing step S5 will be described in more detail with reference to FIGS. 6 and 7. FIG. 6 is a diagram for describing the fifth processing step S5 of the information processing method using the information processing device 100 according to Embodiment 1 of the present invention and for describing a method of determining the parts in the image corresponding to the parts in the drawing in the provisional superimposed diagram. FIG. 6(a) is an example of the provisional superimposed diagram, in which the solid line represents the drawing, and the broken line represents the image obtained by converting the coordinate system. The letters L, M, N, O and P in FIG. 6(a) are symbols used in the following description. Similarly, the letters l, m, n, o and p in FIG. 6(b) are symbols used in the following description. FIG. 7 is a diagram for describing the fifth processing step S5 of the information processing method using the information processing device 100 according to Embodiment 1 of the present invention and for describing how to calculate the overlap indexes.

First, the second determination unit 50 selects one part in the drawing in the provisional superimposed diagram shown in FIG. 6(a), which is an example of the provisional superimposed diagram. Here, as shown in FIG. 6(b), it is assumed that the part L in the drawing is selected. Next, the overlap indexes between the part L in the drawing and each of the parts l, m, n, o and p in the image are calculated.

A method of calculating an overlap index showing the overlap between a part in the drawing and a part in the image will be described with reference to FIG. 7. The overlap indexes are calculated for each of the parts in the provisional superimposed diagram. FIG. 7(a) is a diagram showing a state in which a part in the drawing and a part in the converted image overlap, with respect to one certain part in the provisional superimposed diagram. In FIG. 7(a), the solid line represents the drawing, and the broken line represents the image obtained by converting the coordinate system. FIG. 7(b) is a diagram showing the overlapping area (Intersection) of an area representing the part in the drawing and an area representing the part in the converted image, with respect to the part in the drawing and the part in the image shown in FIG. 7(a). FIG. 7(c) is a diagram showing the combined area (Union) of the area of the part in the drawing and the area of the part in the converted image, with respect to the part in the drawing and the part in the image shown in FIG. 7(a).

FIG. 7(d) is a diagram showing a state in which a part in the drawing and a part in the converted image overlap, with respect to one certain part in another provisional superimposed diagram. In FIG. 7(d), as in FIG. 7(a), the solid line represents the drawing, and the broken line represents the image obtained by converting the coordinate system. FIG. 7(e) is a diagram showing the overlapping area (Intersection) of an area representing the part in the drawing and an area representing the part in the converted image, with respect to the part in the drawing and the part in the image shown in FIG. 7(d). FIG. 7(f) is a diagram showing the combined area (Union) of the area of the part in the drawing and the area of the part in the converted image, with respect to the part in the drawing and the part in the image shown in FIG. 7(d).

The overlap index for the part shown in FIG. 7(a) is a value obtained by dividing the size of the area shown in FIG. 7(b) by the size of the area shown in FIG. 7(c), which is called an intersection over union (IoU) value. Similarly, the overlap index for the part shown in FIG. 7(d) is a value obtained by dividing the size of the area shown in FIG. 7(e) by the size of the area shown in FIG. 7(f).

The diagram of the part shown in FIG. 7(a) is partially taken from the diagram shown in FIG. 4(d). The diagram of the part shown in FIG. 7(d) is partially taken from the diagram shown in FIG. 5(d). When the overlap index for the part shown in FIG. 7(a) and the overlap index for the part shown in FIG. 7(d) are actually calculated, the overlap index for the part shown in FIG. 7(d) is greater than the overlap index for the part shown in FIG. 7(a).

The overlap indexes between the part L in the drawing and each of the parts l, m, n, o and p in the image shown in FIG. 6(b) are calculated by the method described above with reference to FIG. 7. The calculated results are as follows: the overlap index between the part L in the drawing and the part l in the image is 0.9, the overlap index between the part L in the drawing and the part m in the image is 0.0, the overlap index between the part L in the drawing and the part n in the image is 0.0, the overlap index between the part L in the drawing and the part o in the image is 0.0, and the overlap index between the part L in the drawing and the part p in the image is 0.0.

On the basis of this result, the second determination unit 50 determines the part in the image corresponding to the part in the drawing in the provisional superimposed diagram. When the overlap indexes between the part L in the drawing and each of the parts l, m, n, o and p in the image are compared, the overlap index of the part L in the drawing and the part l in the image is the greatest. Therefore, in the fifth processing step S5, the second determination unit 50 of the information processing device 100 according to the present embodiment determines that the part in the image corresponding to the part L in the drawing in the provisional superimposed diagram is the part l in the image.

Next, the second determination unit 50 selects one part from the parts in the drawing for which the corresponding parts in the image have not been determined yet in the provisional superimposed diagram shown in FIG. 6(a), which is an example of the provisional superimposed diagram. Here, it is assumed that the part M in the drawing is selected as shown in FIG. 6(c). Then, the overlap indexes between the part M in the drawing and the parts in the image are calculated. At this time, the part l in the image for which the corresponding part in the drawing has already been determined is excluded. That is, the overlap indexes between the part M in the drawing and each of the parts m, n, o and p in the image are calculated. Thereafter, the same process as that for determining the part in the image corresponding to the part L in the drawing is performed. That is, the overlap indexes between the part M in the drawing and the parts m, n, o and p in the image are compared, and the part in the image having the greatest overlap index is determined as the part in the image corresponding to the part M in the drawing. The same process is performed also for the parts O, N and P in the drawing shown in FIG. 6(a), and the parts in the image corresponding to each of them are determined. To describe the above with reference to FIG. 6(a), the second determination unit 50 determines that the part L in the drawing corresponds to the part l in the image, the part M in the drawing corresponds to the part m in the image, the part N in the drawing corresponds to the part n in the image, the part O in the drawing corresponds to the part o in the image, and the part P in the drawing corresponds to the part p in the image in the fifth processing step S5. As described above, in the present embodiment, the corresponding parts in the image are determined for all of the parts in the drawing in the provisional superimposed diagram.

However, with respect to a certain part in the drawing, when the greatest overlap index among the overlap indexes with the parts in the image is 0.0, in other words, when there is no part in the image which overlaps with the certain part in the drawing, the process is continued with the part in the image corresponding to the certain part in the drawing left unknown. When the number of parts in the image is smaller than the number of parts in the drawing, the corresponding parts in the image are unknown for some of the parts in the drawing, but the process is continued. In FIG. 6, the outline of the object is shown for convenience to show the number of the parts included in the object.

Here, the corresponding parts in the image are determined for all of the parts in the drawing in the provisional superimposed diagram, but the present embodiment is not limited thereto. It is sufficient if no contradiction occurs when the sixth processing step S6, the judgement step J1, and the seventh processing step S7, which will be described later, are performed. For example, the second determination unit 50 may first select one part in the image and calculate the overlap indexes between the selected part in the image and each of the parts in the drawing in the provisional superimposed diagram shown in FIG. 6(a), which is an example of the provisional superimposed diagram. That is, the corresponding parts in the drawing may be determined for all of the parts in the image in the provisional superimposed diagram.

The second determination unit 50 of the information processing device 100 according to the present embodiment outputs the values of the overlap indexes used when the parts in the image corresponding to the parts in the drawing are determined, the provisional corresponding relationship determined by the first determination unit 30, as well as the first information and the second information to the calculation unit 60. Here, the provisional corresponding relationship determined by the first determination unit 30 is the provisional corresponding relationship used when the provisional superimposed diagram is generated.

The sixth processing step S6 of the information processing method using the information processing device 100 according to the present embodiment is a step of calculating the aggregate overlap index of the provisional superimposed diagram by summing the overlap indexes used when the parts in the image corresponding to the parts in the drawing are determined in the provisional superimposed diagram in the fifth processing step S5. The CPU 3 having the function of the calculation unit 60 of the information processing device 100 according to the present embodiment calculates the aggregate overlap index of the provisional superimposed diagram by summing the overlap indexes used when the second determination unit 50 determines the parts in the image corresponding to the parts in the drawing in the provisional superimposed diagram generated by the generation unit 40 in the sixth processing step S6.

An operation of the calculation unit 60 and the sixth processing step S6 will be described in more detail. Referring to FIG. 6, in the fifth processing step S5, the calculation unit 60 sums the overlap index when the part in the image corresponding to the part L in the drawing is determined to be the part l in the image, the overlap index when the part in the image corresponding to the part M in the drawing is determined to be the part m in the image, the overlap index when the part in the image corresponding to the part N in the drawing is determined to be the part n in the image, the overlap index when the part in the image corresponding to the part O in the drawing is determined to be the part o in the image, and the overlap index when the part in the image corresponding to the part P in the drawing is determined to be the part p in the image. The value of the sum is the value of the aggregate overlap index of the provisional superimposed diagram.

When the aggregate overlap index of the provisional superimposed diagram shown in FIG. 4(d) and the aggregate overlap index of the provisional superimposed diagram shown in FIG. 5(d) are actually calculated, the aggregate overlap index of the provisional superimposed diagram shown in FIG. 5(d) is greater than the aggregate overlap index of the provisional superimposed diagram shown in FIG. 4(d) because the overlap indexes for the parts shown in FIG. 7(d) are greater than the overlap indexes for the parts shown in FIG. 7(a).

The judgement step J1 of the information processing method using the information processing device 100 according to the present embodiment is a step of determining whether the fourth processing step S4, the fifth processing step S5, and the sixth processing step S6 have been performed for all of the provisional corresponding relationships outputted in the third processing step S3. In the judgement step J1, the CPU 3 having the function of the control unit 80 of the information processing device 100 according to the embodiment determines whether the operations of the generation unit 40, the second determination unit 50, and the calculation unit 60 have been performed for all of the provisional corresponding relationships outputted by the first determination unit 30.

When, in the judgement step J1, the control unit 80 determines that the fourth processing step S4, the fifth processing step S5, and the sixth processing step S6 have been performed for all of the provisional corresponding relationships outputted in the third processing step S3, the control unit 80 instructs the third determination unit 70 to operate. When, in the judgement step J1, the control unit 80 determines that the fourth processing step S4, the fifth processing step S5, and the sixth processing step S6 have not been performed for all of the provisional corresponding relationships outputted in the third processing step S3, the control unit 80 instructs the generation unit 40 to operate for the provisional corresponding relationships for which the provisional superimposed diagrams have not yet been generated. That is, the fourth processing step S4 by the generation unit 40, the fifth processing step S5 by the second determination unit 50, and the sixth processing step S6 by the calculation unit 60 are repeatedly performed for all of the provisional corresponding relationships outputted by the first determination unit 30 in the third processing step S3.

The calculation unit 60 calculates the aggregate overlap indexes for all of the provisional corresponding relationships outputted by the first determination unit 30. When the control unit 80 determines, in the judgement step J1, that the fourth processing step S4, the fifth processing step S5, and the sixth processing step S6 have been performed for all of the provisional corresponding relationships outputted in the third processing step S3, the calculation unit 60 outputs all of the calculated values of the aggregate overlap indexes, the provisional superimposed diagrams for each of which the aggregate overlap index has been calculated, the provisional corresponding relationships used when the provisional superimposed diagrams were generated, as well as the first information and the second information to the third determination unit 70. That is, the third determination unit 70 of the information processing device 100 according to the present embodiment receives the values of the aggregate overlap indexes calculated by the calculation unit 60 for all of the provisional corresponding relationships outputted by the first determination unit 30, the provisional superimposed diagrams for each of which the aggregate overlap index has been calculated, the provisional corresponding relationships determined by the first determination unit 30 used when the provisional superimposed diagrams were generated by the generation unit 40, as well as the first information and the second information from the calculation unit 60.

The seventh processing step S7 of the information processing method using the information processing device 100 according to the present embodiment is a step of determining the corresponding relationship between the parts in the drawing acquired in the first processing step S1 and the parts in the image acquired in the second processing step S2 on the basis of the aggregate overlap indexes calculated in the sixth processing step S6. The CPU 3 having the function of the third determination unit 70 of the information processing device 100 according to the present embodiment determines the corresponding relationship between the parts in the drawing acquired by the first acquisition unit 10 and the parts in the image acquired by the second acquisition unit 20 on the basis of the aggregate overlap indexes calculated by the calculation unit 60 in the seventh processing step S7.

First, the third determination unit 70 compares all of the values of the aggregate overlap indexes received from the calculation unit 60 and selects the provisional superimposed diagram having the greatest value. Then, the third determination unit 70 determines that the provisional corresponding relationship used when the selected provisional superimposed diagram is generated as the correct corresponding relationship between the parts in the drawing and the parts in the image in the present embodiment. That is, the third determination unit 70 determines the corresponding relationship between the parts in the drawing and the parts in the image in the provisional corresponding relationship used when the provisional superimposed diagram for which the aggregate overlap index having the greatest value is calculated is generated to be the corresponding relationship between the parts in the drawing acquired by the first acquisition unit 10 and the parts in the image acquired by the second acquisition unit 20.

The operation of the third determination unit 70 and the seventh processing step S7 will be described with reference to FIGS. 4 and 5. For convenience of description, it is assumed that the third determination unit 70 received two aggregate overlap indexes from the calculation unit 60: the aggregate overlap index of the provisional superimposed diagram shown in FIG. 4(d) and the aggregate overlap index of the provisional superimposed diagram shown in FIG. 5(d). The third determination unit 70 compares the aggregate overlap index of the provisional superimposed diagram shown in FIG. 4(d) and the aggregate overlap index of the provisional superimposed diagram shown in FIG. 5(d) and selects the provisional superimposed diagram shown in FIG. 5(d) as the provisional superimposed diagram having the greatest value. This is because, as described above in the description of the sixth processing step S6, the aggregate overlap index of the provisional superimposed diagram shown in FIG. 5(d) is greater than the aggregate overlap index of the provisional superimposed diagram shown in FIG. 4(d).

Next, referring to the provisional corresponding relationship used when the provisional superimposed diagram shown in FIG. 5(d) is generated, it can be seen that the part S in the drawing and the part s in the image correspond to each other, the part T in the drawing and the part t in the image correspond to each other, the part U in the drawing and the part u in the image correspond to each other, and the part V in the drawing and the part v in the image correspond to each other, as shown in FIGS. 5(a) and 5(b). Therefore, the third determination unit 70 determines that the corresponding relationship in which the part S in the drawing and the part s in the image correspond to each other, the part T in the drawing and the part t in the image correspond to each other, the part U in the drawing and the part u in the image correspond to each other, and the part V in the drawing and the part v in the image correspond to each other is the corresponding relationship between the parts in FIG. 5(a) showing the drawing acquired by the first acquisition unit 10 and the parts in FIG. 5(b) showing the image acquired by the second acquisition unit 20.

The information processing device 100 according to the present embodiment is a device which performs processing for displaying a drawing and an image having a coordinate system different from that of the drawing in a superimposed manner, and the corresponding relationship between the parts in the drawing and the parts in the image determined by the third determination unit 70 of the information processing device 100 according to the present embodiment is used for displaying the drawing and the image having a coordinate system different from that of the drawing in a superimposed manner. The information processing device 100 according to the present embodiment may output either only the corresponding relationship between the parts in the drawing and the parts in the image, or only the superimposed diagram generated on the basis of the corresponding relationship between the parts in the drawing and the parts in the image determined by the third determination unit 70. For the superimposed diagram described as generated on the basis of the corresponding relationship between the parts in the drawing and the parts in the image determined by the third determination unit 70, the provisional superimposed diagram having the greatest value of the aggregate overlap index generated as a provisional superimposed diagram by the generation unit 40 can be used, so that the information processing device 100 according to the present embodiment can output the superimposed diagram without needing to newly generate a superimposed diagram.

As described above, the information processing device 100 according to the present embodiment can perform processing for displaying a drawing and an image having a coordinate system different from that of the drawing in a superimposed manner even when the drawing is a general drawing. This is because the provisional superimposed diagrams are generated on the basis of the provisional corresponding relationships determined using the first information and the second information, the aggregate overlap indexes of the provisional superimposed diagrams are calculated, and the corresponding relationship between the parts in the drawing and the parts in the image is determined on the basis of the aggregate overlap indexes. Since the local features are not used to calculate the corresponding relationship as in the prior art, it is not necessary to provide information about the features in the drawing, and thus, a general drawing created by a CAD system or the like can be used.

The information processing device 100 according to the present embodiment can perform processing for displaying a drawing and an image having a coordinate system different from that of the drawing in a superimposed manner with high accuracy even when the object includes a plurality of parts of the same appearance. Conventionally, when the object includes a plurality of parts of the same appearance, it has not been possible to perform processing for displaying a drawing and an image having a coordinate system different from that of the drawing in a superimposed manner with high accuracy because there are so many points having the same features. On the other hand, the information processing device 100 according to the present embodiment can perform processing for displaying a drawing and an image having a coordinate system different from that of the drawing in a superimposed manner with high accuracy. This is because the provisional superimposed diagrams are generated on the basis of the provisional corresponding relationships determined using the first information and the second information, the aggregate overlap indexes of the provisional superimposed diagrams are calculated, and the corresponding relationship between the parts in the drawing and the parts in the image is determined on the basis of the aggregate overlap indexes.

Further, since the information processing device 100 according to the present embodiment does not require a manual work by the user, it can easily perform processing for displaying a drawing and an image having a coordinate system different from that of the drawing in a superimposed manner. In addition, conventionally, depending on the skill level, etc. of the user, the time required for processing for displaying a drawing and an image having a coordinate system different from that of the drawing in a superimposed manner may be long. On the other hand, the information processing device 100 according to the present embodiment does not require a manual work by the user, so that it is possible to shorten the time required for processing for displaying a drawing and an image having a coordinate system different from that of the drawing in a superimposed manner.

Further, even when the object includes a plurality of parts of the same appearance, the information processing device 100 according to the present embodiment can shorten the time required for processing for displaying a drawing and an image having a coordinate system different from that of the drawing in a superimposed manner and prevent them from being superimposed in an incorrect corresponding relationship. Conventionally, when the object includes a plurality of parts of the same appearance, the time required for processing for displaying a drawing and an image having a coordinate system different from that of the drawing in a superimposed manner may be long, depending on the processing method, because the corresponding relationship between the feature points in the drawing and the feature points in the image cannot be easily determined due to the existence of a large number of the feature points of the similar local features. Further, when the feature points having the similar local features exist, the corresponding relationship may be determined on the basis of combinations of the parts having the same appearance but actually being different, and thus, a drawing and an image may be erroneously displayed in a superimposed manner on the basis of the mismatched correspondence result.

On the other hand, the information processing device 100 according to the present embodiment can shorten the time required for processing for displaying a drawing and an image having a coordinate system different from that of the drawing in a superimposed manner and prevent a drawing and an image from being displayed in a superimposed manner on the basis of the mismatched correspondence result. This is because the provisional superimposed diagrams are generated on the basis of the provisional corresponding relationships determined using the first information and the second information, the aggregate overlap indexes of the provisional superimposed diagrams are calculated, and the corresponding relationship between the parts in the drawing and the parts in the image is determined on the basis of the aggregate overlap indexes.

The corresponding relationship between the parts in the drawing and the parts in the image and the superimposed diagram generated on the basis of the corresponding relationship between the parts in the drawing and the parts in the image, outputted from the information processing device 100 according to the present embodiment, can be used for various purposes. For example, extrinsic parameters (also called pose parameters) of the camera which captured the object can be estimated using the corresponding relationship between the parts in the drawing and the parts in the image determined by the third determination unit 70 of the information processing device 100 according to the present embodiment and the coordinates of the parts in the drawing and the parts in the image, and a drawing and an image having a coordinate system different from that of the drawing can be superimposed using the estimation result. For example, in some cases, an augmented reality (AR) display is performed by superimposing an image and a drawing having a coordinate system different from that of the image, in which the superimposition of the image and the drawing can be achieved by using the corresponding relationship between the parts in the drawing and the parts in the image outputted from the information processing device 100 according to the present embodiment.

Further, the superimposed drawing and the image having a coordinate system different from that of the drawing displayed on the basis of the output of the information processing device 100 according to the present embodiment can be used, for example, for a work of checking whether a product is manufactured in accordance with a drawing as well as for an inspection work of remotely determining whether a device has abnormality.

In the above description, it is assumed that the IoU value is the overlap index, but the present embodiment is not limited to this. For example, the size itself of the area of overlap between a part in the drawing and a part in the image may be used as the overlap index. Even when the overlap index is set to the size itself of the area of overlap between a part in the drawing and a part in the image, the operation of the information processing device 100 according to the present embodiment and the information processing method using the information processing device 100 according to the present embodiment are not changed.

Alternatively, for example, a length of an outline of overlap between the area of a part in the drawing and the area of a part in the image may be used as the overlap index. Even when the overlap index is set to the length of an outline of overlap between the area of a part in the drawing and the area of a part in the image, the operation of the information processing device 100 according to the present embodiment and the information processing method using the information processing device 100 according to the present embodiment are not changed.

Alternatively, for example, the reciprocal of the sum of the distances between the outline of a part in the drawing and the outline of a part in the image in a region where the area of the part in the drawing and the area of the part in the image do not overlap each other may be used as the overlap index. This can be done first by marking points at equal intervals on both the outline of the part in the drawing and the outline of the part in the image, then calculating the distances between the marked points on the outlines and the sum of the distances, and finally setting the reciprocal of the sum to the overlap index. Even when the overlap index is set to the reciprocal of the sum of the distances between the outline of a part in the drawing and the outline of a part in the image in a region where the area of the part in the drawing and the area of the part in the image do not overlap each other, the operation of the information processing device 100 according to the present embodiment and the information processing method using the information processing device 100 according to the present embodiment are not changed.

It is described above that the fourth processing step S4 by the generation unit 40, the fifth processing step S5 by the second determination unit 50, and the sixth processing step S6 by the calculation unit 60 are repeatedly performed for all of the provisional corresponding relationships outputted by the first determination unit 30 in the third processing step S3 in response to the instruction of the control unit 80 of the information processing device 100 according to the present embodiment. However, the present embodiment is not limited to this. For example, the following may be adopted.

First, for all of the provisional corresponding relationships outputted by the first determination unit 30 in the third processing step S3, the generation unit 40 generates the provisional superimposed diagrams in the fourth processing step S4. Then, the generation unit 40 outputs all of the provisional superimposed diagrams generated for all of the provisional corresponding relationships determined by the first determination unit 30, the provisional corresponding relationships determined by the first determination unit 30, as well as the first information and the second information to the second determination unit 50. The second determination unit 50 calculates the overlap indexes between the parts in the drawing and the parts in the image in all of the provisional superimposed diagrams, and determines the parts in the image corresponding to the parts in the drawing in the provisional superimposed diagrams on the basis of the overlap indexes. Then, the second determination unit 50 outputs the values of the overlap indexes used when the parts in the image corresponding to the parts in the drawing are determined in all of the provisional superimposed diagrams, the provisional corresponding relationships determined by the first determination unit 30, as well as the first information and the second information to the calculation unit 60. The calculation unit 60 calculates the aggregate overlap indexes in all of the provisional superimposed diagrams and outputs the result to the third determination unit 70. The third determination unit 70 compares all of the aggregate overlap indexes received from the calculation unit 60 and determines the corresponding relationship between the parts in the drawing acquired by the first acquisition unit 10 and the parts in the image acquired by the second acquisition unit 20.

In the case of such a configuration, it can be said that the first determination unit 30, the generation unit 40, the second determination unit 50, the calculation unit 60, and the third determination unit 70 of the information processing device 100 according to the present embodiment each have a function of controlling itself in addition to the above-described functions.

The order of the first processing step S1 and the second processing step S2 may be reversed.

It is described above that the first information and the second information acquired by the first acquisition unit 10 and the second acquisition unit 20 are loaded in the storage device 2, but the present embodiment is not limited to this. The first information and the second information may be stored in an external device, and the first acquisition unit 10 and the second acquisition unit 20 may acquire the first information and the second information from the external device via the network connection device 7.

Although it is described above that the first acquisition unit 10, the second acquisition unit 20, the first determination unit 30, the generation unit 40, the second determination unit 50, the calculation unit 60, and the third determination unit 70 of the information processing device 100 according to the present embodiment are functions of the CPU 3, the following is also possible. First, a program including the first processing step S1, the second processing step S2, the third processing step S3, the fourth processing step S4, the fifth processing step S5, the sixth processing step S6, the seventh processing step S7, and the judgement step J1 is stored in the storage device 2. The CPU 3 reads the program from the storage device 2 and executes the program. Of course, the location where the program is stored is not limited to the storage device 2.

### Embodiment 2

A configuration of an information processing device 200 according to Embodiment 2 of the present invention will be described. The information processing device 200 according to Embodiment 2 of the present invention can be realized using the computer 1, similarly to the information processing device 100 according to Embodiment 1 of the present invention. In Embodiment 2 of the present invention, only the differences from Embodiment 1 of the present invention will be described, and the description of the same parts as those of Embodiment 1 of the present invention will be omitted.

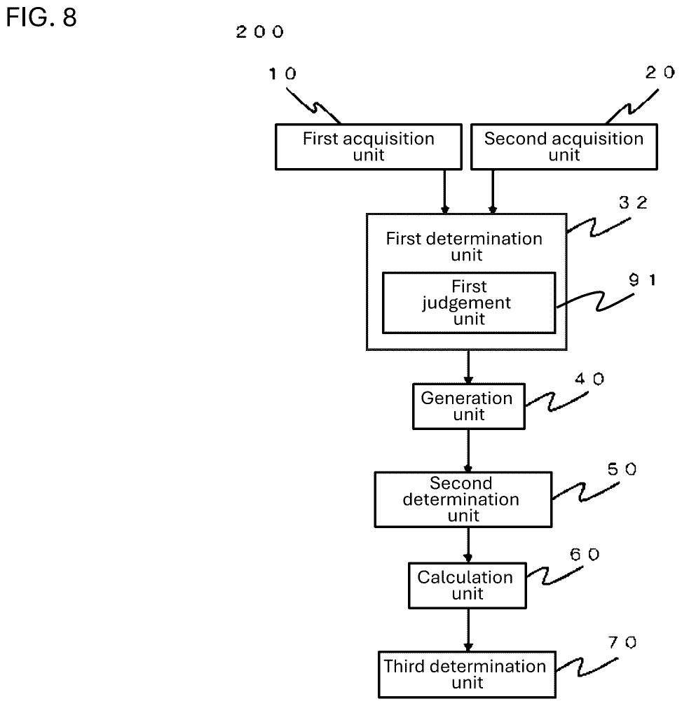

FIG. 8 is a block diagram showing a functional configuration of the information processing device 200 according to Embodiment 2 of the present invention. Each of the functions of the information processing device 200 according to the present embodiment is realized by the CPU 3 of the computer 1 shown in FIG. 1. As shown in FIG. 8, the information processing device 200 according to the present embodiment includes the first acquisition unit 10, the second acquisition unit 20, a first determination unit 32, the generation unit 40, the second determination unit 50, the calculation unit 60, and the third determination unit 70. The first determination unit 32 of the information processing device 200 according to the present embodiment includes a first judgement unit 91. The information processing device 200 according to the present embodiment also includes the control unit 80, similarly to the information processing device 100 according to Embodiment 1 of the present invention, but it is not shown in FIG. 8. The control unit 80 of the information processing device 200 according to the present embodiment controls operations of the first acquisition unit 10, the second acquisition unit 20, the first determination unit 32, the generation unit 40, the second determination unit 50, the calculation unit 60, and the third determination unit 70.

The information processing device 200 according to the present embodiment is different from Embodiment 1 of the present invention in that the first determination unit 32 includes the first judgement unit 91. The first judgement unit 91 judges whether the types of the parts in the image corresponding to the parts in the drawing are the same as the types of the parts in the drawing in a provisional corresponding relationship. When the first judgement unit 91 judges that they are of the same types, the first determination unit 32 outputs the provisional corresponding relationship to the generation unit 40.

An operation of the first determination unit 32 including the first judgement unit 91 and the third processing step of an information processing method using the information processing device 200 according to the present embodiment will be described in detail with reference to FIGS. 4 and 5. A method will be described by which the first determination unit 32 of the information processing device 200 according to the present embodiment determines a provisional corresponding relationship between the parts in the drawing and the parts in the image in the third processing step. For example, as shown in FIG. 4(a), the first determination unit 32 selects 4 parts with a symbol of X, Y, Z or W from the 17 parts in the drawing. Similarly, for example, as shown in FIG. 4(b), the first determination unit 32 selects 4 parts with a symbol of x, y, z or w from the 17 parts in the image.

The first determination unit 32 provisionally determines the parts in the image corresponding to the selected parts in the drawing. Here, it is provisionally determined that the part X in the drawing corresponds to the part x in the image, the part Y in the drawing corresponds to the part y in the image, the part Z in the drawing corresponds to the part z in the image, and the part W in the drawing corresponds to the part w in the image. The provisionally determined relationship between the parts in the drawing and the parts in the image is the provisional corresponding relationship in FIG. 4.

Since the first judgement unit 91 of the first determination unit 32 judges whether the types of the parts in the image corresponding to the parts in the drawing are the same as the types of the parts in the drawing in the provisional corresponding relationship, first, it judges whether the type of the part x in the image corresponding to the part X in the drawing is the same as the type of the part X in the drawing. Next, the first judgement unit 91 of the first determination unit 32 judges whether the type of the part y in the image corresponding to the part Y in the drawing is the same as the type of the part Y in the drawing. Similarly, it is judged whether the type of the part z in the image corresponding to the part Z in the drawing is the same as the type of the part Z in the drawing, and whether the type of the part w in the image corresponding to the part W in the drawing is the same as the type of the part W in the drawing.

When the types of the corresponding parts are judged to be the same by the first judgement unit 91, the first determination unit 32 outputs this provisional corresponding relationship to the generation unit 40. As shown in FIG. 4, the type of the part x in the image corresponding to the part X in the drawing is meter, and the type of the part X in the drawing is also meter, so that the first judgement unit 91 judges that the type of the part x in the image corresponding to the part X in the drawing is the same as the type of the part X in the drawing. Similarly, the first judgement unit 91 judges that the type of the part Y in the drawing is the same as the type of the part y in the image, the type of the part Z in the drawing is the same as the type of the part z in the image, and the type of the part W in the drawing is the same as the type of the part w in the image. Therefore, the first determination unit 32 outputs the provisional corresponding relationship in which the part X in the drawing corresponds to the part x in the image, the part Y in the drawing corresponds to the part y in the image, the part Z in the drawing corresponds to the part z in the image, and the part W in the drawing corresponds to the part w in the image to the generation unit 40.

When it is judged to be negative by the first judgement unit 91, the first determination unit 32 does not output this provisional corresponding relationship to the generation unit 40. For example, assume that the provisional corresponding relationship in FIG. 5 suggests that the part S in the drawing in FIG. 5(a) corresponds to the part t in the image in FIG. 5(b). However, the type of the part t in the image corresponding to the part S in the drawing is nameplate, but the type of the part S in the drawing is meter. Therefore, the first judgement unit 91 judges that the type of the part t in the image corresponding to the part S in the drawing is not the same as the type of the part S in the drawing (negative determination). As a result, the first determination unit 32 does not output, to the generation unit 40, the provisional corresponding relationship which suggests that the part S in the drawing in FIG. 5(a) corresponds to the part t in the image in FIG. 5(b). In the case of a negative judgement by the first judgement unit 91, the first determination unit 32 newly selects the parts in the drawing and the parts in the image to determine another provisional corresponding relationship.

As described above, the information processing device 200 according to the present embodiment can shorten the time required for processing for displaying a drawing and an image having a coordinate system different from that of the drawing in a superimposed manner. This is because, when the first judgement unit 91 judges that the types of the parts in the image corresponding to the parts in the drawing are the same as the types of the parts in the drawing in a provisional corresponding relationship, the first determination unit 32 outputs this provisional corresponding relationship to the generation unit 40, and thus, it is possible to prevent the outputs of mismatched corresponding relationships.

It is described above that the first judgement unit 91 judges whether the types of the parts in the image corresponding to the parts in the drawing are the same as the types of the parts in the drawing. Alternatively, however, the first judgement unit 91 may judge whether the types of the parts in the drawing corresponding to the parts in the image are the same as the types of the parts in the image.

### Embodiment 3

A configuration of an information processing device 300 according to Embodiment 3 of the present invention will be described. The information processing device 300 according to Embodiment 3 of the present invention can be realized using the computer 1, similarly to the information processing devices according to Embodiments 1 and 2 of the present invention. In Embodiment 3 of the present invention, only the differences from Embodiments 1 and 2 of the present invention will be described, and the description of the same parts as those of Embodiments 1 and 2 of the present invention will be omitted.

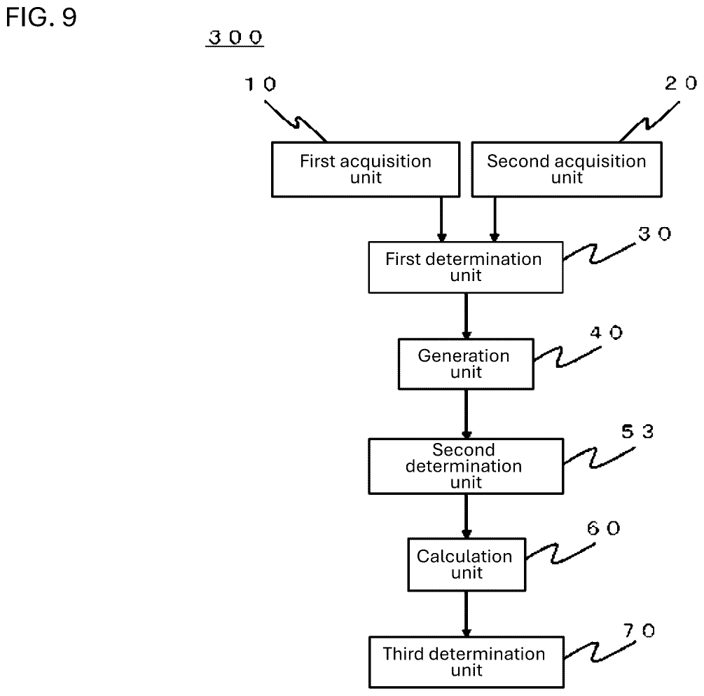

FIG. 9 is a block diagram showing a functional configuration of the information processing device 300 according to Embodiment 3 of the present invention. Each of the functions of the information processing device 300 according to the present embodiment is realized by the CPU 3 of the computer 1 shown in FIG. 1. As shown in FIG. 9, the information processing device 300 according to the present embodiment includes the first acquisition unit 10, the second acquisition unit 20, the first determination unit 30, the generation unit 40, a second determination unit 53, the calculation unit 60, and the third determination unit 70. The information processing device 300 according to the present embodiment also includes the control unit 80, similarly to the information processing devices according to Embodiments 1 and 2 of the present invention, but it is not shown in FIG. 9. The control unit 80 of the information processing device 300 according to the present embodiment controls operations of the first acquisition unit 10, the second acquisition unit 20, the first determination unit 30, the generation unit 40, the second determination unit 53, the calculation unit 60, and the third determination unit 70.

The information processing device 300 according to the present embodiment is different from Embodiments 1 and 2 of the present invention in an operation of the second determination unit 53 and the fifth processing step. The second determination unit 53 of the information processing device 300 according to the present embodiment calculates the overlap indexes showing the overlaps between the parts in the drawing and the parts in the image in the provisional superimposed diagrams by using the first information and the second information. When the parts in the image corresponding to the parts in the drawing in a provisional superimposed diagram are determined on the basis of the overlap indexes, when the overlap index of a part in the image with respect to a part in the drawing is equal to or greater than a predetermined value, the part in the image is determined to be the part which corresponds to the part in the drawing in the provisional superimposed diagram.

An operation of the second determination unit 53 of the information processing device 300 according to the present embodiment and the fifth processing step of an information processing method using the information processing device 300 according to the present embodiment will be described in detail with reference to FIG. 6. First, the second determination unit 53 of the information processing device 300 according to the present embodiment selects one part in the drawing in the provisional superimposed diagram shown in FIG. 6(a), which is an example of the provisional superimposed diagram. Here, as shown in FIG. 6(b), the part L in the drawing is selected.

Next, the overlap indexes between the part L in the drawing and each of the parts l, m, n, o and p in the image are calculated. Here, the IoU values are calculated as the overlap indexes. Then, the second determination unit 53 compares the overlap indexes between the part L in the drawing and each of the parts l, m, n, o and p in the image. The overlap index between the part L in the drawing and the part l in the image is the greatest. The second determination unit 53 determines whether the value of the overlap index between the part L in the drawing and the part l in the image, which is the greatest, is equal to or greater than a predetermined value, and, when the value is equal to or greater than the predetermined value, determines that the part in the image corresponding to the part L in the drawing in the provisional superimposed diagram is the part l in the image. That is, when the value of the overlap index between the part L in the drawing and the part l in the image, which is the greatest, is less than the predetermined value, the second determination unit 53 does not determine that the part in the image corresponding to the part L in the drawing in the provisional superimposed diagram is the part l in the image. Here, the predetermined value is, for example, 0.5.

When the value of the overlap index between the part L in the drawing and the part l in the image, which is the greatest, is less than the predetermined value, the second determination unit 53 cannot determine the parts in the image corresponding to the parts in the drawing in the provisional superimposed diagram, and thus, the process is stopped. Since the second determination unit 53 stops the processing, nothing is outputted to the calculation unit 60. When the second determination unit 53 stops the processing, that is, when the fifth processing step is stopped, the control unit 80 skips the sixth processing step S6 and performs the judgement step J1.

Even when the value of the overlap index between the part L in the drawing and the part l in the image, which is the greatest, is less than the predetermined value, the second determination unit 53 may continue the processing without stopping the processing as described above, assuming that the part in the image corresponding to this part in the drawing is unknown.

As described above, the information processing device 300 according to the present embodiment can shorten the time required for processing for displaying a drawing and an image having a coordinate system different from that of the drawing in a superimposed manner. This is because, when the second determination unit 53 determines the parts in the image corresponding to the parts in the drawing in a provisional superimposed diagram on the basis of the overlap indexes, when the overlap index of a part in the image with respect to a part in the drawing is equal to or greater than a predetermined value, the part in the image is determined to be the part which corresponds to the part in the drawing in the provisional superimposed diagram. In other words, this is because, when the overlap indexes are less than a predetermined value, the second determination unit 53 stops the process, which means that the provisional corresponding relationships which are unlikely to be the correct corresponding relationship are not outputted to the calculation unit 60 and the third determination unit 70, resulting in reducing the number of comparisons which otherwise have to be made by the third determination unit 70.

When the second determination unit 53 is configured to continue the process even when the values of the overlap indexes are less than the predetermined value, the information processing device 300 according to the present embodiment can output the results by excluding the mismatched corresponding relationships between the parts in the drawing and the parts in the image.

### Embodiment 4

A configuration of an information processing device 400 according to Embodiment 4 of the present invention will be described. The information processing device 400 according to Embodiment 4 of the present invention can be realized using the computer 1, similarly to the information processing devices according to Embodiments 1 to 3 of the present invention. In Embodiment 4 of the present invention, only the differences from Embodiments 1 to 3 of the present invention will be described, and the description of the same parts as those of Embodiments 1 to 3 of the present invention will be omitted.

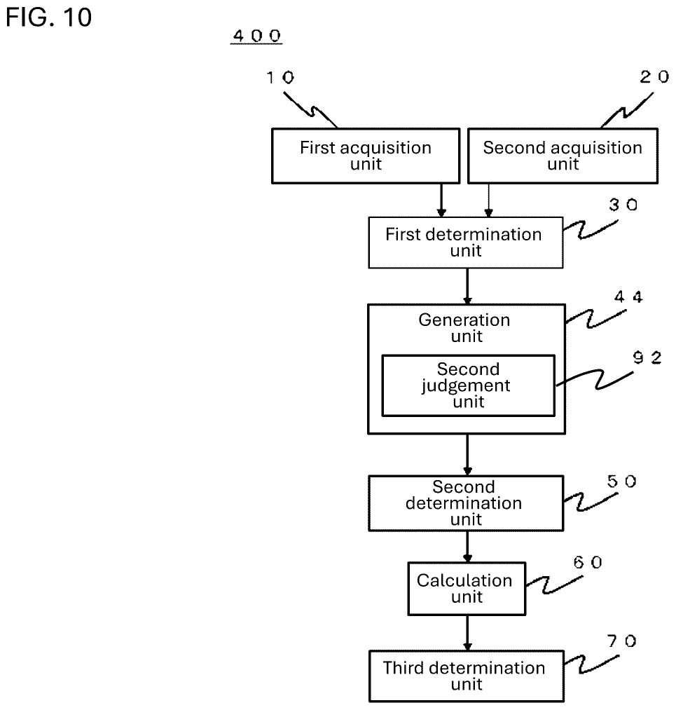

FIG. 10 is a block diagram showing a functional configuration of the information processing device 400 according to Embodiment 4 of the present invention. Each of the functions of the information processing device 400 according to the present embodiment is realized by the CPU 3 of the computer 1 shown in FIG. 1. As shown in FIG. 10, the information processing device 400 according to the present embodiment includes the first acquisition unit 10, the second acquisition unit 20, the first determination unit 30, a generation unit 44, the second determination unit 50, the calculation unit 60, and the third determination unit 70. The generation unit 44 of the information processing device 400 according to the present embodiment includes a second judgement unit 92. The information processing device 400 according to the present embodiment also includes the control unit 80, similarly to the information processing devices according to Embodiments 1 to 3 of the present invention, but it is not shown in FIG. 10. The control unit 80 of the information processing device 400 according to the present embodiment controls operations of the first acquisition unit 10, the second acquisition unit 20, the first determination unit 30, the generation unit 44, the second determination unit 50, the calculation unit 60, and the third determination unit 70.

The information processing device 400 according to the present embodiment is different from Embodiments 1 to 3 of the present invention in that the generation unit 44 includes the second judgement unit 92. When generating a provisional superimposed diagram, the second judgement unit 92 judges whether the drawing or the image with its coordinate system converted is one obtained either by rotating a drawing or an image before the conversion of the coordinate system between 90 degrees and 270 degrees or by flipping a drawing or an image before the conversion of the coordinate system. When the second judgement unit 92 judges that neither is the case, the generation unit 44 generates a provisional superimposed diagram to output it to the second determination unit 50.

An operation of the generation unit 44 including the second judgement unit 92 and the fourth processing step will be described in detail with reference to FIG. 4. First, the generation unit 44 matches the coordinate system of the drawing and the coordinate system of the image on the basis of the provisional corresponding relationship determined by the first determination unit 30. In the fourth processing step, the generation unit 44 calculates a projection transformation matrix in the same manner as performed by the generation unit 40 and converts the image shown in FIG. 4(b) using the obtained projection transformation matrix. The image obtained by converting the image shown in FIG. 4(b) is the image shown in FIG. 4(c). In the fourth processing step, the second judgement unit 92 of the generation unit 44 judges whether the image with its coordinate system converted is one obtained either by rotating an image before the conversion of the coordinate system between 90 degrees and 270 degrees or by flipping an image before the conversion of the coordinate system. That is, the second judgement unit 92 of the generation unit 44 judges whether FIG. 4(c) showing the converted image is obtained either by rotating FIG. 4(b) showing an image before the conversion between 90 degrees and 270 degrees or by flipping FIG. 4(b) showing the image before the conversion. Although it is described above that the generation unit 44 of the information processing device 400 according to the present embodiment converts the coordinate system of the image into the coordinate system of the drawing, the generation unit 44 may convert the coordinate system of the drawing into the coordinate system of the image in the same manner as performed by the generation unit 40 of the information processing devices according to Embodiments 1 to 3 of the present invention. When the generation unit 44 converts the coordinate system of the drawing into the coordinate system of the image, the second judgement unit 92 judges whether the drawing with its coordinate system converted is one obtained either by rotating a drawing before the conversion of the coordinate system between 90 degrees and 270 degrees or by flipping a drawing before the conversion of the coordinate system.

Next, in the fourth processing step, when the second judgement unit 92 judges that neither is the case, the generation unit 44 generates a provisional superimposed diagram by superimposing the drawing and the image obtained by converting the coordinate system. That is, when the second judgement unit 92 judges that the conversion of the coordinate system is performed either by the rotation between 90 degrees and 270 degrees or by the flipping, the generation unit 44 does not generate a provisional superimposed diagram. To describe with reference to FIG. 4, when the second judgement unit 92 judges that neither is the case in the fourth processing step, the generation unit 44 generates the diagram shown in FIG. 4(d) by superimposing the diagram shown in FIG. 4(a) and the diagram shown in FIG. 4(c). On the other hand, when the second judgement unit 92 judges that the conversion of the coordinate system is performed either by the rotation between 90 degrees and 270 degrees or by the flipping, the generation unit 44 does not generate the image shown in FIG. 4(d).

When it is said that the image with its coordinate system converted is an image obtained by rotating an image before the conversion of the coordinate system between 90 degrees and 270 degrees, it means that the top and the bottom of the image are reversed before and after the conversion of the coordinate system. Also, the flipping includes both horizontal and vertical flipping.

In the case of a negative judgement by the second judgement unit 92, the generation unit 44 generates a provisional superimposed diagram and outputs the generated provisional superimposed diagram to the second determination unit 50. In the case of a judgement by the second judgement unit 92 that the conversion of the coordinate system is performed either by the rotation between 90 degrees and 270 degrees or by the flipping, the generation unit 44 does not generate a provisional superimposed diagram, and thus the process is stopped. Since the generation unit 44 stops the processing, nothing is outputted to the second determination unit 50. When the generation unit 44 stops the processing, that is, when the fourth processing step is stopped, the control unit 80 skips the fifth processing step S5 and the sixth processing step S6 and performs the judgement step J1.

As described above, the information processing device 400 according to the present embodiment can shorten the time required for processing for displaying a drawing and an image having a coordinate system different from that of the drawing in a superimposed manner. This is because, when the second judgement unit 92 of the generation unit 44 gives a negative judgement, the generation unit 44 generates a provisional superimposed diagram and outputs it to the second determination unit 50. In other words, this is because, when the second judgement unit 92 of the generation unit 44 judges that the conversion of the coordinate system is performed either by the rotation between 90 degrees and 270 degrees or by the flipping, the generation unit 44 stops the process, so that the provisional superimposed diagrams based on the provisional corresponding relationships which are unlikely to be the correct corresponding relationship are not outputted to the second determination unit 50, the calculation unit 60, and the third determination unit 70, and thus, the number of comparisons which the third determination unit 70 otherwise has to make can be reduced.

The angle setting for the judgement is described above as between 90 degrees and 270 degrees, but this angle setting is an example, and the judgement may be made using a different angle setting. For example, the angle setting may be between 100 degrees and 260 degrees.

### Embodiment 5

A configuration of an information processing device 500 according to Embodiment 5 of the present invention will be described. The information processing device 500 according to Embodiment 5 of the present invention can be realized using the computer 1, similarly to the information processing devices according to Embodiments 1 to 4 of the present invention. In Embodiment 5 of the present invention, only the differences from Embodiments 1 to 4 of the present invention will be described, and the description of the same parts as those of Embodiments 1 to 4 of the present invention will be omitted.

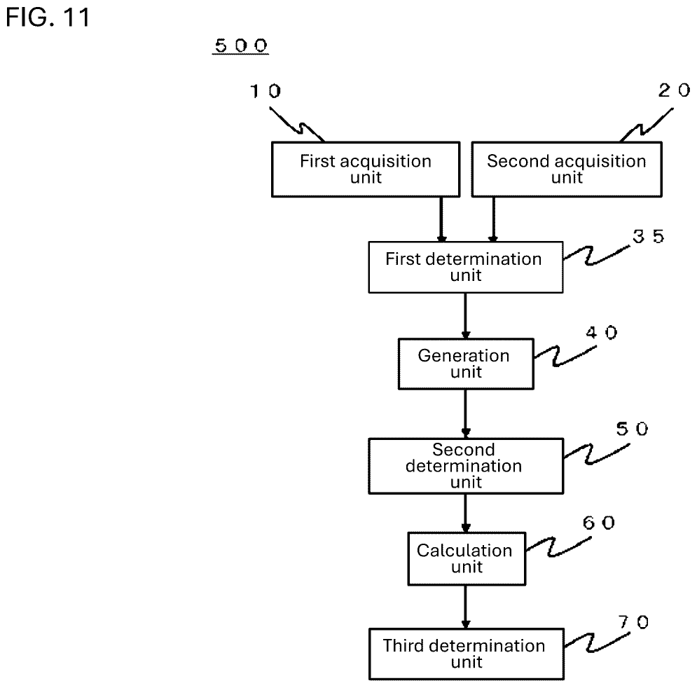

FIG. 11 is a block diagram showing a functional configuration of the information processing device 500 according to Embodiment 5 of the present invention. Each of the functions of the information processing device 500 according to the present embodiment is realized by the CPU 3 of the computer 1 shown in FIG. 1. As shown in FIG. 11, the information processing device 500 according to the present embodiment includes the first acquisition unit 10, the second acquisition unit 20, a first determination unit 35, the generation unit 40, the second determination unit 50, the calculation unit 60, and the third determination unit 70. The information processing device 500 according to the present embodiment also includes the control unit 80, similarly to the information processing devices according to Embodiments 1 to 4 of the present invention, but it is not shown in FIG. 11. The control unit 80 of the information processing device 500 according to the present embodiment controls operations of the first acquisition unit 10, the second acquisition unit 20, the first determination unit 35, the generation unit 40, the second determination unit 50, the calculation unit 60, and the third determination unit 70.

The information processing device 500 according to the present embodiment is different from Embodiments 1 to 4 of the present invention in the operation of the first determination unit 35 and the third processing step. When selecting the parts in the drawing and the parts in the image, the first determination unit 35 of the information processing device 500 according to the present embodiment selects them at random and then determines an arbitrary number of the provisional corresponding relationships between the parts in the drawing and the parts in the image.

In Embodiments 1 to 4 of the present invention, it is described that the provisional corresponding relationships between the parts in the drawing and the parts in the image are determined for all of the combinations of the parts in the drawing and the parts in the image. On the other hand, in the present embodiment, the provisional corresponding relationships between the parts in the drawing and the parts in the image are not determined for all of the combinations of the parts in the drawing and the parts in the image, but an arbitrary number of the provisional corresponding relationships are determined by randomly selecting the parts in the drawing and the parts in the image. That is, the information processing device 500 according to the present embodiment adopts a method of random sample consensus (RANSAC) for the first determination unit 35 to determine the provisional corresponding relationships between the parts in the drawing and the parts in the image.

The arbitrary number of the provisional corresponding relationships between the parts in the drawing and the parts in the image to be determined by the first determination unit 35 is determined as follows, for example. When 4 parts are selected from the nine parts in the drawing and 4 parts are selected from the nine parts in the image, the total number of the provisional corresponding relationships is 381024 according to ₉C₄×₉P₄. Here, the probability of a randomly selected provisional corresponding relationship being correct is 0.033%. To obtain the correct corresponding relationship with a probability of 99%, 13923 trials are required. Therefore, when there are 9 parts in each of the drawing and the image, the first determination unit 35 of the information processing device 500 according to the present embodiment should determine 13923 combinations of the provisional corresponding relationships between the parts in the drawing and the parts in the image by randomly selecting the parts in the drawing and the parts in the image.

As described above, the information processing device 500 according to the present embodiment can shorten the time required for processing for displaying a drawing and an image having a coordinate system different from that of the drawing in a superimposed manner. This is because the first determination unit 35 does not determine the provisional corresponding relationships between the parts in the drawing and the parts in the image for all of the combinations of the parts in the drawing and the parts in the image, but determines an arbitrary number of the provisional corresponding relationships by randomly selecting the parts in the drawing and the parts in the image. In other words, this is because the information processing device 500 according to the present embodiment adopts the RANSAC method for the first determination unit 35 to determine the provisional corresponding relationships between the parts in the drawing and the parts in the image.

### Embodiment 6

A configuration of an information processing device 600 according to Embodiment 6 of the present invention will be described. The information processing device 600 according to Embodiment 6 of the present invention can be realized using the computer 1, similarly to the information processing devices according to Embodiments 1 to 5 of the present invention. In Embodiment 6 of the present invention, only the differences from Embodiments 1 to 5 of the present invention will be described, and the description of the same parts as those of Embodiments 1 to 5 of the present invention will be omitted.

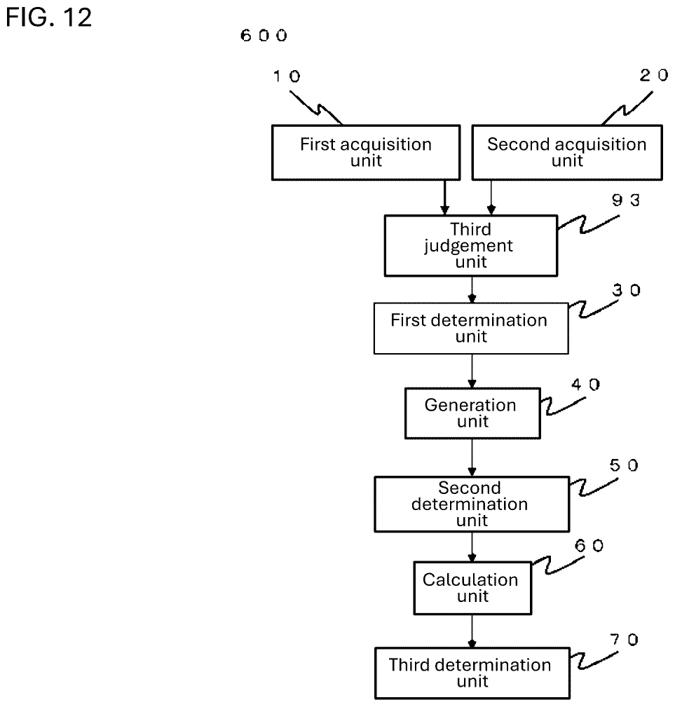

FIG. 12 is a block diagram showing a functional configuration of the information processing device 600 according to Embodiment 6 of the present invention. Each of the functions of the information processing device 600 according to the present embodiment is realized by the CPU 3 of the computer 1 shown in FIG. 1. As shown in FIG. 12, the information processing device 600 according to the present embodiment includes the first acquisition unit 10, the second acquisition unit 20, a third judgement unit 93, the first determination unit 30, the generation unit 40, the second determination unit 50, the calculation unit 60, and the third determination unit 70. The information processing device 600 according to the present embodiment also includes the control unit 80, similarly to the information processing devices according to Embodiments 1 to 5 of the present invention, but it is not shown in FIG. 12. The control unit 80 of the information processing device 600 according to the present embodiment controls operations of the first acquisition unit 10, the second acquisition unit 20, the third judgement unit 93, the first determination unit 30, the generation unit 40, the second determination unit 50, the calculation unit 60, and the third determination unit 70.

The information processing device 600 according to the present embodiment is different from Embodiments 1 to 5 of the present invention in that it includes the third judgement unit 93. The third determination unit 93 of the information processing device 600 according to the present embodiment judges whether the number of the parts in the drawing included in the first information and the number of the parts in the image included in the second information match. Alternatively, it is judged whether the difference between the number of the parts in the drawing and the number of the parts in the image is equal to or greater than a predetermined value. For example, it is judged whether the difference is 3 or more.

When the third judgement unit 93 judges that the two numbers do not match, the information processing device 600 according to the present embodiment stops the processing, and the third judgement unit 93 outputs nothing to the first determination unit 30. When the third judgement unit 93 judges that the two numbers are equal, the third judgement unit 93 outputs the first information and the second information to the first determination unit 30.

As described above, the information processing device 600 according to the present embodiment can prevent the first determination unit 30, the generation unit 40, the second determination unit 50, the calculation unit 60, and the third determination unit 70 from performing processing on the basis of the incorrect first information or the incorrect second information. This is because, when the third judgement unit 93 gives a negative judgement, the information processing device 600 according to the present embodiment stops the processing. The following is considered as the reasons why the number of the parts in the drawing included in the first information and the number of the parts in the image included in the second information do not match. For example, the reasons include such possibilities that the objects represented by the drawing and the image are different, or that there is an error in the result of the object detection on which the information about the parts in the image included in the second information is based.

### Embodiment 7

A configuration of an information processing device 700 according to Embodiment 7 of the present invention will be described. The information processing device 700 according to Embodiment 7 of the present invention can also be realized using the computer 1, similarly to the information processing devices according to Embodiments 1 to 6 of the present invention. In Embodiment 7 of the present invention, only the differences from Embodiments 1 to 6 of the present invention will be described, and the description of the same parts as those of Embodiments 1 to 6 of the present invention will be omitted.

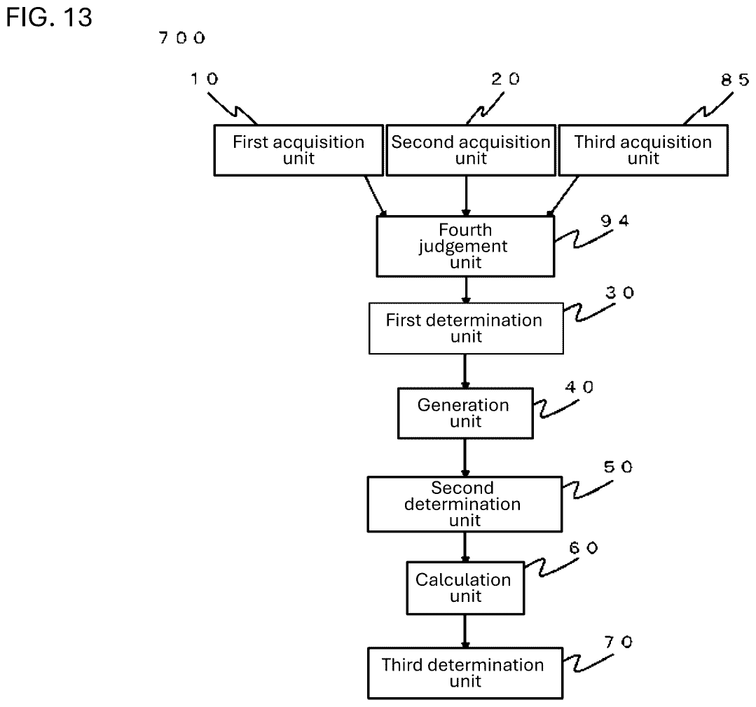

FIG. 13 is a block diagram showing a functional configuration of the information processing device 700 according to Embodiment 7 of the present invention. Each of the functions of the information processing device 700 according to the present embodiment is realized by the CPU 3 of the computer 1 shown in FIG. 1. As shown in FIG. 13, the information processing device 700 according to the present embodiment includes the first acquisition unit 10, the second acquisition unit 20, a third acquisition unit 85, a fourth judgement unit 94, the first determination unit 30, the generation unit 40, the second determination unit 50, the calculation unit 60, and the third determination unit 70. The information processing device 700 according to the present embodiment also includes the control unit 80, similarly to the information processing devices according to Embodiments 1 to 6 of the present invention, but it is not shown in FIG. 13. The control unit 80 of the information processing device 700 according to the present embodiment controls operations of the first acquisition unit 10, the second acquisition unit 20, the third acquisition unit 85, the fourth judgement unit 94, the first determination unit 30, the generation unit 40, the second determination unit 50, the calculation unit 60, and the third determination unit 70.

The information processing device 700 according to the present embodiment is different from the information processing devices according to Embodiments 1 to 6 of the present invention in that it includes the third acquisition unit 85 and the fourth judgement unit 94. The third acquisition unit 85 acquires the information about the position from which the image is captured. Specifically, the third acquisition unit 85 acquires the position of the imaging device when the image represented by the second information is captured by the imaging device using a positioning method such as a global navigation satellite system (GNSS), an inertial measurement unit (IMU), an inertial navigation system (INS), an ultra-wide band (UWB), or another positioning method, which are represented by the Global Positioning System (GPS). The fourth judgement unit 94 judges whether the distance between the position of the object included in the first information and the position acquired by the third acquisition unit 85 is equal to or greater than a predetermined value.

An information processing method using the information processing device 700 according to the present embodiment includes an auxiliary step before the third processing step S3, unlike the information processing methods using the information processing devices according to Embodiments 1 to 6 of the present invention. The auxiliary step is a step of acquiring the information about the position from which the image is captured and judging whether the distance between the position of the object included in the first information and the position acquired by the third acquisition unit 85 is equal to or greater than a predetermined value.

When the fourth judgement unit 94 judges that the distance is equal to or greater than the predetermined value, the information processing device 600 according to the present embodiment stops the processing, and the fourth judgement unit 94 outputs nothing to the first determination unit 30. When the fourth judgement unit 94 gives a negative judgement, the fourth judgement unit 94 outputs the first information and the second information to the first determination unit 30. Here, the predetermined value is, for example, 5 meters.

As described above, the information processing device 700 according to the present embodiment can prevent the first determination unit 30, the generation unit 40, the second determination unit 50, the calculation unit 60, and the third determination unit 70 from performing processing on the basis of the incorrect first information or the incorrect second information. This is because, when the fourth judgement unit 94 judges that the distance is equal to or greater than the predetermined value, the information processing device 700 according to the present embodiment stops the processing. This is because the fact that the distance between the position of the object included in the first information and the position acquired by the third acquisition unit 85 is equal to or greater than the predetermined value shows that the object represented by the drawing and the object represented by the image are highly likely to be different objects.

In the present embodiment, it is assumed that the first information includes information about the position of the object.

### Embodiment 8

A configuration of an information processing device 800 according to Embodiment 8 of the present invention will be described. The information processing device 800 according to Embodiment 8 of the present invention can also be realized using the computer 1, similarly to the information processing devices according to Embodiments 1 to 7 of the present invention. In Embodiment 8 of the present invention, only the differences from Embodiments 1 to 7 of the present invention will be described, and the description of the same parts as those of Embodiments 1 to 7 of the present invention will be omitted.

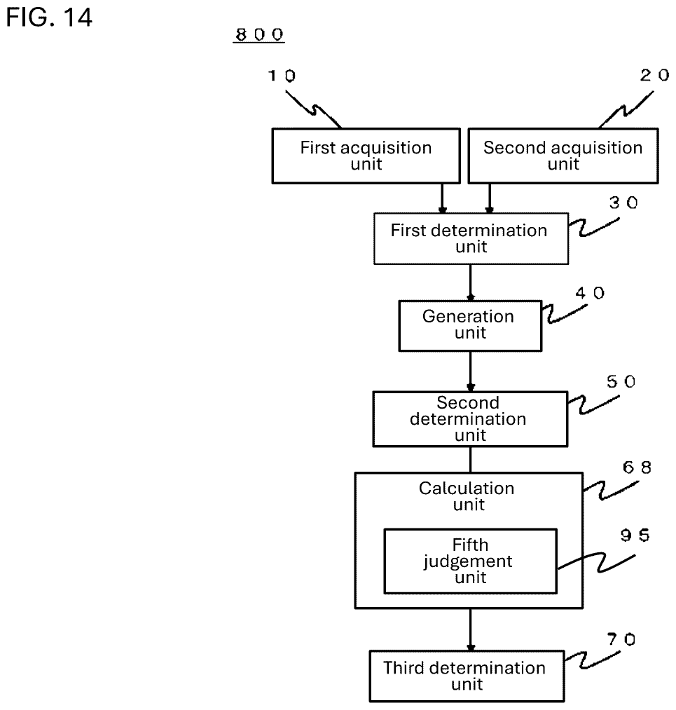

FIG. 14 is a block diagram showing a functional configuration of the information processing device 800 according to Embodiment 8 of the present invention. Each of the functions of the information processing device 800 according to the present embodiment is realized by the CPU 3 of the computer 1 shown in FIG. 1. As shown in FIG. 14, the information processing device 800 according to the present embodiment includes the first acquisition unit 10, the second acquisition unit 20, the first determination unit 30, the generation unit 40, the second determination unit 50, a calculation unit 68, and the third determination unit 70. The calculation unit 68 of the information processing device 800 according to the present embodiment includes a fifth judgement unit 95. The information processing device 800 according to the present embodiment also includes the control unit 80, similarly to the information processing devices according to Embodiments 1 to 7 of the present invention, but it is not shown in FIG. 14. The control unit 80 of the information processing device 800 according to the present embodiment controls operations of the first acquisition unit 10, the second acquisition unit 20, the first determination unit 30, the generation unit 40, the second determination unit 50, the calculation unit 68, and the third determination unit 70.

The information processing device 800 according to the present embodiment is different from Embodiments 1 to 7 of the present invention in that the calculation unit 68 includes the fifth judgement unit 95. The fifth judgement unit 95 determines whether the calculated aggregate overlap index is equal to or greater than a predetermined value. When the fifth judgement unit judges that the calculated aggregate overlap index is equal to or greater than the predetermined value, the third determination unit 70 determines the corresponding relationship between the parts in the drawing acquired by the first acquisition unit 10 and the parts in the image acquired by the second acquisition unit 20 on the basis of the aggregate overlap index judged to be equal to or greater than the predetermined value by the fifth judgement unit.

An operation of the calculation unit 68 including the fifth judgement unit 95 as well as the sixth processing step and the seventh processing step included in the information processing method using the information processing device 800 according to the present embodiment will be described in detail. First, in the sixth processing step, the calculation unit 68 sums the overlap indexes used when the second determination unit 50 determines the parts in the image corresponding to the parts in the drawing in the provisional superimposed diagram generated by the generation unit 40 to obtain the aggregate overlap index of the provisional superimposed diagram. Here, it is assumed that the overlap indexes are IoU values. Next, in the sixth processing step, the fifth judgement unit 95 of the calculation unit 68 judges whether the calculated aggregate overlap index is equal to or greater than a predetermined value.

In the sixth processing step, when the fifth judgement unit 95 of the calculation unit 68 judges that the aggregate overlap index is equal to or greater than the predetermined value, the calculation unit 68 outputs the provisional corresponding relationship used when the provisional superimposed diagram for which the aggregate overlap index equal to or greater than the predetermined value is calculated is generated as well as the first information and the second information to the third determination unit 70. When the fifth judgement unit 95 of the calculation unit 68 judges that the aggregate overlap index is equal to or greater than the predetermined value in the sixth processing step, the control unit 80 instructs to skip the judgement step J1 and to perform the seventh processing step.

On the basis of the aggregate overlap index judged to be equal to or greater than the predetermined value by the fifth judgement unit 95, the third determination unit 70 determines the provisional corresponding relationship used when the provisional superimposed diagram for which the aggregate overlap index equal to or greater than the predetermined value is calculated is generated as the correct corresponding relationship between the parts in the drawing and the parts in the image in the present embodiment. That is, the third determination unit 70 determines the corresponding relationship between the parts in the drawing and the parts in the image in the provisional corresponding relationship used when the provisional superimposed diagram for which the aggregate overlap index judged to be equal to or greater than the predetermined value by the fifth judgement unit 95 is calculated is generated as the corresponding relationship between the parts in the drawing acquired by the first acquisition unit 10 and the parts in the image acquired by the second acquisition unit 20.

When the fifth judgement unit 95 of the calculation unit 68 gives a negative judgement in the sixth processing step, the control unit 80 performs the judgement step J1 in the same manner as in Embodiments 1 to 7 of the present invention. Here, the predetermined value is, for example, a value obtained by subtracting 1 from the number of the parts in the drawing. When the number of the parts in the drawing is 8, the predetermined value is 7.

As described above, the information processing device 800 according to the present embodiment can shorten the time required for processing for displaying a drawing and an image having a coordinate system different from that of the drawing in a superimposed manner. This is because the third determination unit 70 determines the corresponding relationship between the parts in the drawing acquired by the first acquisition unit 10 and the parts in the image acquired by the second acquisition unit 20 on the basis of the aggregate overlap index judged to be equal to or greater than the predetermined value by the fifth judgement unit 95 of the calculation unit 68. The provisional corresponding relationship used when the provisional superimposed diagram for which the aggregate overlap index judged to be equal to or greater than the predetermined value by the fifth judgement unit 95 is calculated is generated is highly likely to be the correct corresponding relationship. Therefore, the information processing device 800 according to the present embodiment can end the process at the time when the aggregate overlap index of the provisional superimposed diagram which is considered to be based on the correct corresponding relationship is calculated.

The present invention allows for any combination of the embodiments and modifications as well as appropriate alternation and omission thereof within the scope of the invention.

### DESCRIPTION OF SYMBOLS

1 . . . computer,
2 . . . storage device,
3 . . . CPU,
4 . . . input device,
5 . . . output device,
6 . . . auxiliary storage device,
7 . . . network connection device,
8 . . . bus,
10 . . . first acquisition unit,
20 . . . second acquisition unit,
30, 32, 35 . . . first determination unit,
40, 44 . . . generation unit,
50, 53 . . . second determination unit,
60, 68 . . . calculation unit,
70 . . . third determination unit,
80 . . . control unit,
85 . . . third acquisition unit,
91 . . . first judgement unit,
92 . . . second judgement unit,
93 . . . third judgement unit,
94 . . . fourth judgement unit,
95 . . . fifth judgement unit,
100,200,300,400,500,600,700,800 . . . information processing device

1. An information processing device comprising:
a processor to execute a program; and
a memory to store the program which, when executed by the processor, performs:
a first acquisition process of acquiring first information which is information about a drawing of an object having a plurality of parts and includes information about the plurality of parts in the drawing;
a second acquisition process of acquiring second information which is information about an image of the object having a coordinate system different from that of the drawing and includes information about a plurality of parts in the image;
a first determination process of selecting parts in the drawing and parts in the image and determining a provisional corresponding relationship between the parts in the drawing and the parts in the image by using the first information and the second information;
a generation process of generating a provisional superimposed diagram by matching the coordinate system of the drawing and the coordinate system of the image and thus superimposing the drawing and the image on the basis of the provisional corresponding relationship;
a second determination process of calculating overlap indexes showing overlaps between the parts in the drawing and the parts in the image in the provisional superimposed diagram using the first information and the second information and determining the parts in the image corresponding to the parts in the drawing in the provisional superimposed diagram on the basis of the overlap indexes;
a calculation process of summing the overlap indexes used when in the second determination process the parts in the image corresponding to the parts in the drawing in the provisional superimposed diagram are determined to calculate an aggregate overlap index of the provisional superimposed diagram; and
a third determination process of determining a corresponding relationship between the parts in the drawing acquired in the first acquisition process and the parts in the image acquired in the second acquisition process on the basis of the aggregate overlap index.

2. The information processing device according to claim 1, wherein an intersection over union (IoU) value is used as each of the overlap indexes.

3. The information processing device according to claim 1,
wherein the first determination process
includes a first judgement process of judging whether types of the parts in the image corresponding to the parts in the drawing are the same as types of the parts in the drawing or whether types of the parts in the drawing corresponding to the parts in the image are the same as types of the parts in the image in the provisional corresponding relationship and
outputs for the use in the generation process the provisional corresponding relationship if, in the first judgement process, it is determined that the types are the same.

4. The information processing device according to claim 2,
wherein the first determination process
includes a first judgement process of judging whether types of the parts in the image corresponding to the parts in the drawing are the same as types of the parts in the drawing or whether types of the parts in the drawing corresponding to the parts in the image are the same as types of the parts in the image in the provisional corresponding relationship and
outputs for the use in the generation process the provisional corresponding relationship if, in the first judgement process, it is determined that the types are the same.

5. The information processing device according to claim 1,
wherein, when determining the parts in the image corresponding to the parts in the drawing in the provisional superimposed diagram, it is determined in the second determination process that a part in the image corresponds to a part in the drawing in the provisional superimposed diagram if the overlap index between the parts is equal to or greater than a predetermined value.

6. The information processing device according to claim 2,
wherein, when determining the parts in the image corresponding to the parts in the drawing in the provisional superimposed diagram, it is determined in the second determination process that a part in the image corresponds to a part in the drawing in the provisional superimposed diagram if the overlap index between the parts is equal to or greater than a predetermined value.

7. The information processing device according to claim 1,
wherein the generation process
includes a second judgement process of judging, when generating the provisional superimposed diagram, whether the drawing or the image with its coordinate system converted is obtained either by rotating the drawing or the image before the conversion of the coordinate system between 90 degrees and 270 degrees or by flipping it
to generate the provisional superimposed diagram and output it for the use in the second determination process if a negative judgement is given in the second judgement process.

8. The information processing device according to claim 2,
wherein the generation process
includes a second judgement process of judging, when generating the provisional superimposed diagram, whether the drawing or the image with its coordinate system converted is obtained either by rotating the drawing or the image before the conversion of the coordinate system between 90 degrees and 270 degrees or by flipping it
to generate the provisional superimposed diagram and output it for the use in the second determination process if a negative judgement is given in the second judgement process.

9. The information processing device according to claim 1,
wherein, when selecting the parts in the drawing and the parts in the image, in the first determination process they are randomly selected and an arbitrary number of the provisional corresponding relationship between the parts in the drawing and the parts in the image are determined.

10. The information processing device according to claim 2,
wherein, when selecting the parts in the drawing and the parts in the image, in the first determination process they are randomly selected and an arbitrary number of the provisional corresponding relationship between the parts in the drawing and the parts in the image are determined.

11. The information processing device according to claim 1, wherein the program, when executed by the processor, further performs
a third judgement process of judging whether a number of the parts in the drawing included in the first information and a number of the parts in the image included in the second information match, and
wherein, if in the third judgement process a negative judgement is given, the processing is stopped.

12. The information processing device according to claim 2, wherein the program, when executed by the processor, further performs
a third judgement process of judging whether a number of the parts in the drawing included in the first information and a number of the parts in the image included in the second information match, and
wherein, if in the third judgement process a negative judgement is given, the processing is stopped.

13. The information processing device according to claim 1, wherein the program, when executed by the processor, further performs:
a third acquisition process of acquiring information about a position where the image was captured; and
a fourth judgement process of judging whether a distance between a position of the object included in the first information and the position acquired in the third acquisition process is equal to or greater than a predetermined value,
wherein, if in the fourth judgement process it is judged that the distance is equal to or greater than the predetermined value, the processing is stopped.

14. The information processing device according to claim 2, wherein the program, when executed by the processor, further performs:
a third acquisition process of acquiring information about a position where the image was captured; and
a fourth judgement process of judging whether a distance between a position of the object included in the first information and the position acquired in the third acquisition process is equal to or greater than a predetermined value,
wherein, if in the fourth judgement process it is judged that the distance is equal to or greater than the predetermined value, the processing is stopped.

15. The information processing device according to claim 1,
wherein the calculation process includes a fifth judgement process of judging whether the calculated aggregate overlap index is equal to or greater than a predetermined value, and
wherein, if in the fifth judgement process it is judged that the calculated aggregate overlap index is equal to or greater than the predetermined value, in the third determination process the corresponding relationship between the parts in the drawing acquired in the first acquisition process and the parts in the image acquired in the second acquisition process is determined on the basis of the aggregate overlap index judged to be equal to or greater than the predetermined value in the fifth judgement process.

16. The information processing device according to claim 2,
wherein the calculation process includes a fifth judgement process of judging whether the calculated aggregate overlap index is equal to or greater than a predetermined value, and
wherein, if in the fifth judgement process it is judged that the calculated aggregate overlap index is equal to or greater than the predetermined value, in the third determination process the corresponding relationship between the parts in the drawing acquired in the first acquisition process and the parts in the image acquired in the second acquisition process is determined on the basis of the aggregate overlap index judged to be equal to or greater than the predetermined value in the fifth judgement process.

17. An information processing method comprising:
a first process of acquiring first information which is information about a drawing of an object having a plurality of parts and includes information about the plurality of parts in the drawing;
a second process of acquiring second information which is information about an image of the object having a coordinate system different from that of the drawing and includes information about a plurality of parts in the image;
a third process of selecting parts in the drawing and parts in the image and determining a provisional corresponding relationship between the parts in the drawing and the parts in the image by using the first information and the second information;
a fourth process of generating a provisional superimposed diagram by matching the coordinate system of the drawing and the coordinate system of the image and thus superimposing the drawing and the image on the basis of the provisional corresponding relationship;
a fifth process of calculating overlap indexes showing overlaps between the parts in the drawing and the parts in the image in the provisional superimposed diagram using the first information and the second information and determining the parts in the image corresponding to the parts in the drawing in the provisional superimposed diagram on the basis of the overlap indexes;
a sixth process of summing the overlap indexes used when the parts in the image corresponding to the parts in the drawing in the provisional superimposed diagram are determined in the fifth process and calculating an aggregate overlap index of the provisional superimposed diagram; and
a seventh process of determining a corresponding relationship between the parts in the drawing acquired in the first process and the parts in the image acquired in the second process on the basis of the aggregate overlap index.

18. A non-transitory storage medium storing an information processing program which causes a computer to execute:
a first process of acquiring first information which is information about a drawing of an object having a plurality of parts and includes information about the plurality of parts in the drawing;
a second process of acquiring second information which is information about an image of the object having a coordinate system different from that of the drawing and includes information about a plurality of parts in the image;
a third process of selecting parts in the drawing and parts in the image and determining a provisional corresponding relationship between the parts in the drawing and the parts in the image by using the first information and the second information;
a fourth process of generating a provisional superimposed diagram by matching the coordinate system of the drawing and the coordinate system of the image and thus superimposing the drawing and the image on the basis of the provisional corresponding relationship;
a fifth process of calculating overlap indexes showing overlaps between the parts in the drawing and the parts in the image in the provisional superimposed diagram using the first information and the second information and determining the parts in the image corresponding to the parts in the drawing in the provisional superimposed diagram on the basis of the overlap indexes;
a sixth process of summing the overlap indexes used when the parts in the image corresponding to the parts in the drawing in the provisional superimposed diagram are determined in the fifth process and calculating an aggregate overlap index of the provisional superimposed diagram; and
a seventh process of determining a corresponding relationship between the parts in the drawing acquired in the first process and the parts in the image acquired in the second process on the basis of the aggregate overlap index.
